(19) United States
(12) Patent Application Publication
(10) Pub. No.: US 2026/0365197 A1
(43) Pub. Date: Nov. 19, 2026

(54) OBJECT BOUNDARY DETECTION FOR AUTONOMOUS AND SEMI-AUTONOMOUS SYSTEMS AND APPLICATIONS

(71) Applicant: NVIDIA Corporation, Santa Clara, CA (US)

(72) Inventor: Rui SHEN, San Jose, CA (US)

(21) Appl. No.: 19/207,089

(22) Filed: May 13, 2025

(51) Int. Cl. B60W 60/00

(52) U.S. Cl. CPC B60W 60/001

(57) ABSTRACT

In various examples, techniques are described for generating an object boundary representation associated with an object depicted in an image. A machine learning model predicts a set of Fourier coefficients associated with a Fourier descriptor defining a boundary representation, as well as a number of time-domain keypoints associated with the boundary representation. During post-processing, the time-domain keypoints are converted into spatial-domain keypoints using inverse Fourier transformation. By varying the number of predicted Fourier coefficients, the disclosed techniques are operable to generate boundary representations having differing degrees of accuracy and requiring differing amounts of computational resources. The boundary representation techniques are therefore suitable for on-device deployment where near real-time boundary representation may be a priority, and computational resources may be limited, as well as for execution in a server and/or cloud environment where low-latency boundary representation may not be required, and computational resources may not be constrained.

### TECHNICAL FIELD

Embodiments of the present disclosure relate generally to object boundary detection and, more specifically, to generating accurate boundary representations associated with one or more detected objects included in an image.

### BACKGROUND

In the field of object boundary representation, existing methods may represent the boundary of an object in the spatial domain. These existing methods may determine a bounding box or other boundary polygon including a fixed number of vertices and/or other points. Alternatively, these methods may determine a fixed number of control points defining, e.g., a Bezier curve representing an object boundary. Still other existing methods may determine a binary segmentation mask, e.g., a pixel-level mask where each pixel takes the value of 1 or 0 indicating whether or not the pixel represents a portion of the detected object. One drawback of these existing methods is that increasingly complex object shapes may require a significant increase in the number of vertices, control points, and/or binary mask pixels to accurately represent an object boundary. Other spatial domain representations that express vertices or other points in polar coordinates may not generate accurate boundaries for objects having one or more concave surfaces.

Other existing boundary representation methods may include a frequency-domain Fourier descriptor having a fixed, predetermined number of coefficients. A machine learning model generates values for the fixed number of Fourier coefficients, which are then used to reconstruct an object boundary in the spatial domain. One drawback of these methods is that the reconstructed boundary may have rounded corners as a result of the combination of the finite number of Fourier harmonics associated with the fixed, predetermined number of Fourier coefficients.

### SUMMARY

Embodiments of the present disclosure relate to accurate object boundary detection from imagery by learning a Fourier descriptor. Systems and methods are disclosed that accurately represent a boundary of an object detected within an image by determining both a quantity of Fourier coefficients and a quantity N of spatial-domain keypoints to be generated. The disclosed techniques include a Fourier descriptor head having a degree K. A trained machine learning model included in the Fourier descriptor head estimates a quantity (2K+1) of complex Fourier coefficients based on at least (2K+1) original or sampled spatial-domain points. The machine learning model also determines the quantity N of spatial-domain keypoints to be generated, and the disclosed techniques generate the N spatial-domain keypoints using inverse Fourier transform at one or more time steps based on the estimated Fourier coefficients. The disclosed techniques may also train the machine learning model based on one or more loss functions and a data set including one or more ground truth object/boundary pairs.

In contrast to conventional systems, the systems and methods of the present disclosure are operable to generate object boundary representations associated with complex shapes, including shapes having one or more concave regions. The generated boundary representations may be more accurate than simple axis-aligned bounding boxes, or bounding polygons having a fixed, predetermined number of vertices. The disclosed techniques may also adjust the computational and/or storage requirements of the machine learning model based on a desired use case. For example, an embodiment of the present disclosure may include a Fourier descriptor head having a relatively low degree K, and may be suitable for deployment in, e.g., a robotic, autonomous vehicle, and/or other on-device platform where near real-time generation of object boundaries may be critical, and where computing and/or storage resources may be limited. A different embodiment of the present disclosure may include a Fourier descriptor head having a relatively high degree L, where K<<L. This embodiment may be deployed in a cloud computing environment or other environment having fewer constraints on computing and/or storage resources, or where near real-time object boundary detection is not critical. The disclosed techniques may also be suitable as a drop-in replacement for an object boundary regression head included in one or more existing object detection models.

### BRIEF DESCRIPTION OF THE DRAWINGS

The present systems and methods for accurate object boundary detection from imagery by learning a Fourier descriptor are described in detail below with reference to the attached drawing figures, wherein:

FIG. 1 illustrates a computing device configured to implement one or more aspects of various embodiments;

FIG. 2 is a more detailed illustration of the training engine of FIG. 1, according to various embodiments;

FIG. 3 illustrates a flow diagram of a method for training a machine learning model, according to various embodiments;

FIG. 4 is a more detailed illustration of the inference engine of FIG. 1, according to various embodiments;

FIG. 5 illustrates a flow diagram of a method for generating a boundary representation, according to various embodiments;

FIG. 6A is an example of sensor locations having corresponding fields of view or sensory fields for example autonomous or semi-autonomous machines, in accordance with at least some embodiments of the present disclosure;

FIG. 6B is an illustration of an example of component and sensor locations on an autonomous or semi-autonomous vehicle, in accordance with at least some embodiments of the present disclosure;

FIG. 6C is a block diagram of an example system architecture for an autonomous or semi-autonomous vehicle, robot, and/or other machine type, in accordance with at least some embodiments of the present disclosure;

FIG. 6D is a block diagram of an example architecture of a computing system—such as a system-on-a-chip (SoC)—in accordance with at least some embodiments of the present disclosure;

FIG. 6E is a system diagram for communication between cloud-based server(s) and an example autonomous or semi-autonomous vehicle, robot, and/or other machine type, in accordance with at least some embodiments of the present disclosure;

FIG. 7 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure; and

FIG. 8 is a block diagram of an example computing device, in accordance with at least some embodiments of the present disclosure.

### DETAILED DESCRIPTION

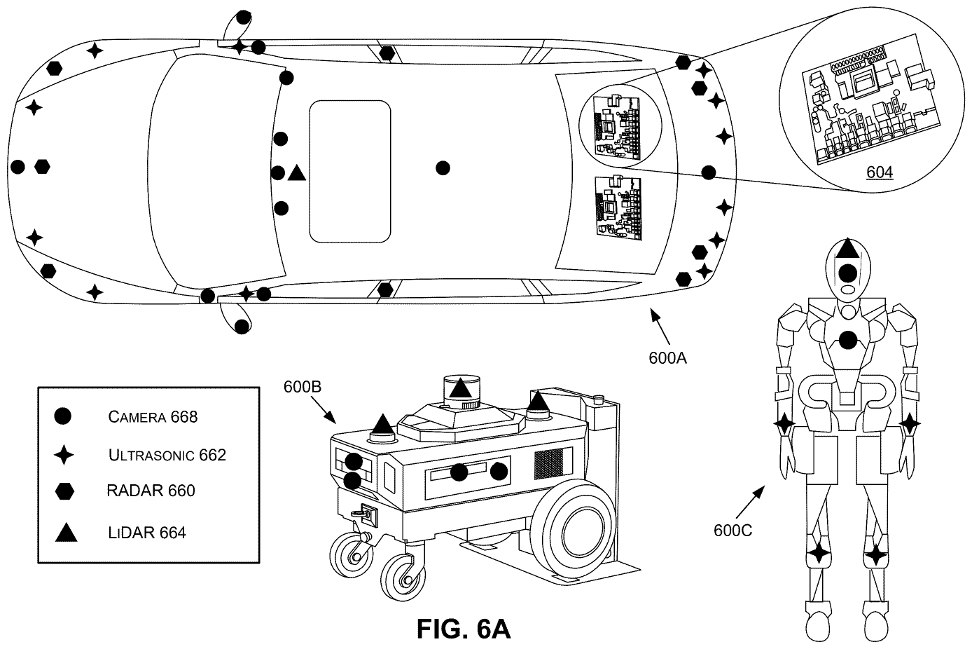

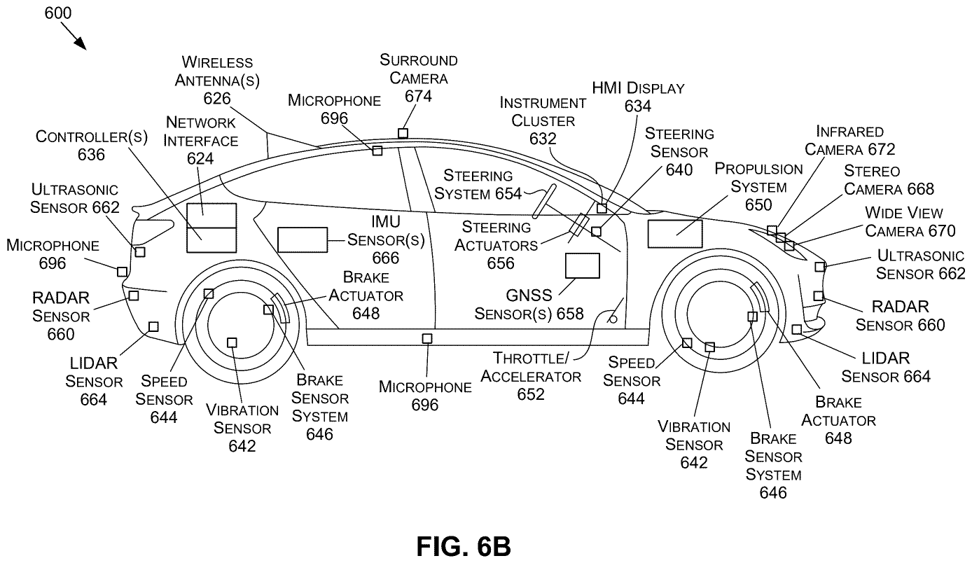

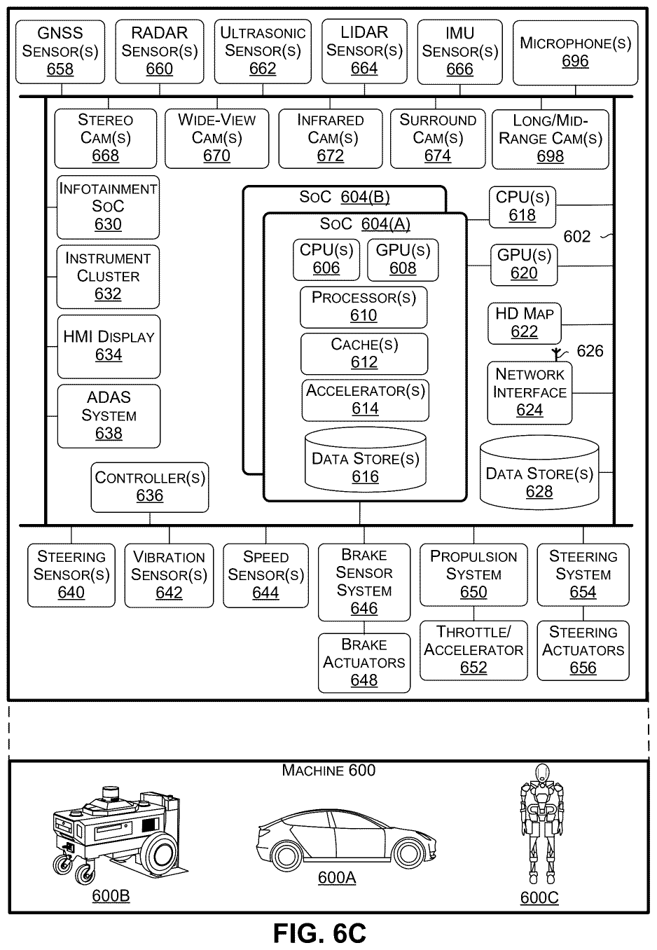

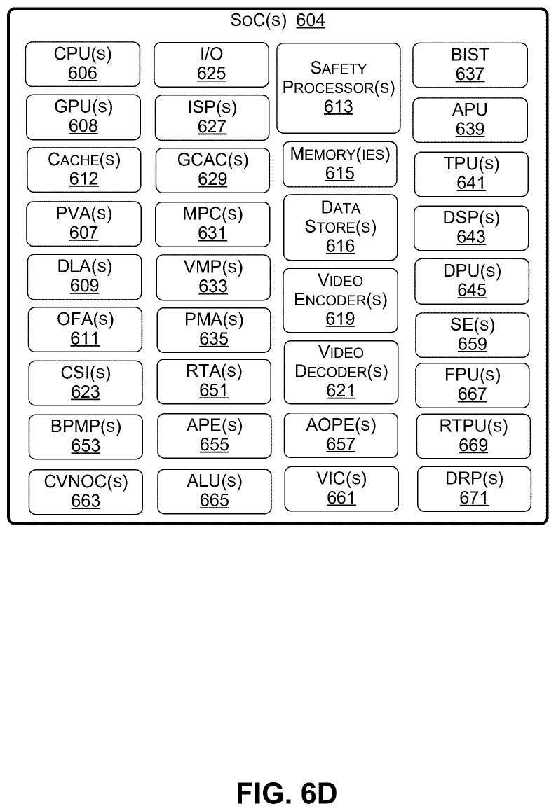

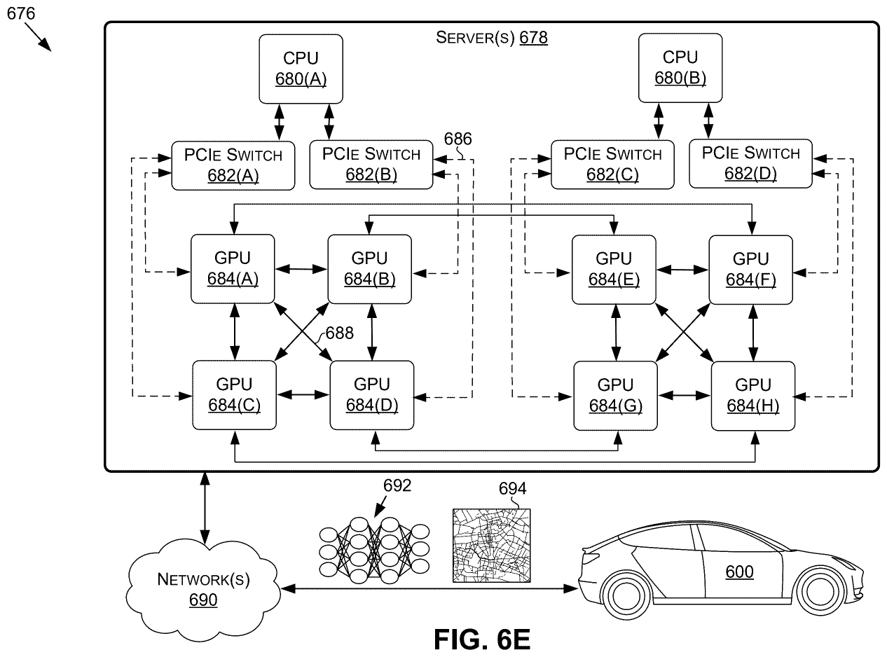

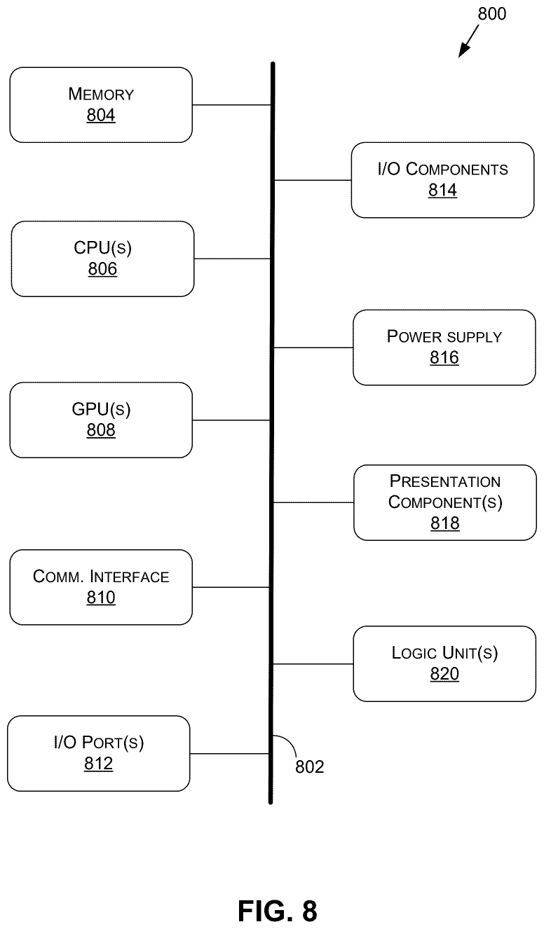

Systems and methods are disclosed related to accurate object boundary detection from imagery by learning a Fourier descriptor. Although the present disclosure may be described with respect to an example autonomous or semi-autonomous vehicle, robot, and/or other machine type 600 (alternatively referred to herein as “vehicle 600,” “ego-vehicle 600,” “machine 600,” “ego-machine 600,” “robot 600,” and/or “ego-robot 600,” an example of which is described with respect to FIGS. 6A-6E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to object boundary representation in autonomous or semi-autonomous machine applications, this is not intended to be limiting, and the systems and methods described herein may be used in augmented reality (AR), virtual reality (VR), mixed reality (MR), robotics, security and surveillance (e.g., smart cities), industrial manufacturing, simulation, and/or any other technology spaces where object boundary representation may be used. In some embodiments, the systems, methods, and/or processes described herein may be executed using similar components, features, and/or functionality to those of example machine 600 of FIGS. 6A-6E, and/or example computing device 800 of FIG. 8.

Systems and methods are disclosed related to generating object boundary representations associated with one or more objects depicted in an input image. Although the present disclosure may be described with respect to generating an object boundary representation associated with a single object depicted in an image, this is not intended to be limiting. For example, the systems and methods described herein may be used, without limitation, to generate object boundary representations associated with multiple objects depicted in a single input image. In addition, although the use of deep neural networks (DNN) is primarily described, this is not intended to be limiting, and other model types may be used—such as transformer models, convolutional neural networks, generative models, etc.—without departing from the scope of the present disclosure.

As discussed herein, conventional techniques for object boundary representation may generate a bounding box or other bounding polygon having a fixed, predetermined number of vertices. Other conventional techniques may calculate a fixed, predetermined number of control points associated with, e.g., a Bezier curve describing an object boundary representation. Still other techniques may generate a fixed, predetermined number of time-domain Fourier coefficients which may then be used to generate points defining an object boundary representation. These inflexible techniques may produce inaccurate boundary representations associated with complex objects, and are not adaptable to multiple use cases that may have differing requirements for accuracy, inference speed, and computing resource requirements.

To improve the generating of object boundary representations, the disclosed techniques are operable to predict both a set of Fourier coefficients used to describe an object boundary representation, and a quantity of time-domain time steps used to calculate spatial-domain keypoints included in the object boundary representation. Various embodiments of the disclosed technique are operable to vary a degree K associated with a Fourier descriptor, allowing the techniques to adjust the accuracy, inference speed, and computing resource requirements to adapt to multiple use cases. By adjusting both the degree of a Fourier descriptor and a number of keypoints to be included in an object boundary representation, the disclosed techniques may generate more accurate object boundary representations for both simple and complex objects, while respecting constraints on accuracy, inference speed, and computing resource requirements.

A training engine receives ground truth image/boundary pairs included in a training dataset, where each image/boundary pair includes both a depiction of an object and an object boundary representation associated with the object. Each object boundary representation includes either zero or three or more spatial-domain keypoints included in the object boundary representation. In an instance where an object boundary representation includes an N-sided bounding polygon where N is necessarily greater than or equal to three, the ground truth object boundary representation may include N keypoints representing the vertices of the bounding polygon. In an instance where the ground truth object boundary representation includes a circular or other elliptical object boundary, the ground truth object boundary representation may include zero keypoints. The training engine may transmit the ground truth image to a deep neural network (DNN) model that will be trained to predict coefficients associated with a Fourier descriptor having a degree K, and a quantity N of time-domain keypoints.

A point sampler included in the training engine may sample additional points included in a ground truth object boundary representation, based on a degree K associated with the Fourier descriptor to be learned by the DNN. For a Fourier descriptor of degree K, the point sampler may sample a quantity of points such that the number of sampled points and the number of ground truth keypoints sum to a quantity greater than or equal to (2K+1). The point sampler saves the ground truth object boundary representation, the number of keypoints, and the spatial locations of the ground truth keypoints for subsequent loss value calculations.

The DNN model receives a ground truth image from the training dataset. The DNN model predicts a quantity (2K+1) of complex Fourier coefficients, where K represents the degree of the Fourier descriptor to be learned by the DNN model. The DNN model also predicts a quantity N that denotes a number of time-domain keypoints. In one embodiment, the DNN model may predict keypoints that are uniformly spaced in the time domain. In these embodiments, the quantity N of keypoints is sufficient to determine uniformly spaced time-domain time steps. In an alternative embodiment, the DNN model may predict keypoints that are non-uniformly spaced in the time domain. In this embodiment, the DNN model predicts not only the quantity N of time-domain keypoints, but also a time-domain time step associated with each of the N keypoints, where the time step values are drawn from the interval [0,1).

A boundary output module included in the training engine calculates an object boundary representation based on the predicted Fourier coefficients and the predicted number of keypoints. In an embodiment where the N keypoints are uniformly spaced in the time domain, the boundary output module determines time-domain time steps associated with each of the N keypoints by distributing the N keypoints uniformly along the time interval [0,1). In an embodiment where the N keypoints are non-uniformly spaced in the time domain, the boundary output module associates each of the N keypoints with the corresponding time-domain time step value predicted by the DNN model. The boundary output module transforms each keypoint from the time domain to the spatial domain by performing an inverse Fourier transform based on the time step associated with the keypoint and the learned Fourier descriptor.

The training engine includes a loss calculator that evaluates one or more loss functions based on the object boundary representation calculated by the boundary output module and the ground truth object boundary representation included in the training dataset. Based on the one or more loss function values, the training engine iteratively modifies one or more adjustable parameters included in the DNN model. The training engine may continue to modify the DNN model for a predetermined number of iterations, or until one or more of the loss function values are below one or more predetermined thresholds. The training engine produces a trained DNN model and transmits the trained DNN model to an inference engine.

At inference time, the inference engine receives an input image including zero, one, or more objects. In an instance where the image includes one or more objects, the trained DNN model predicts a quantity (2K+1) of Fourier coefficients, where K represents the degree of the Fourier descriptor learned by the trained DNN model. The trained DNN model also predicts a quantity N denoting a number of spatial-domain keypoints. In embodiments where the keypoints are non-uniformly spaced in the time domain, the trained DNN model also predicts a time-domain time step associated with each of the N keypoints.

A postprocessing module included in the inference engine calculates spatial-domain keypoint locations for each of the N keypoints by performing inverse Fourier transformation based on the predicted Fourier coefficients and calculated (or in some embodiments, predicted) time-domain time steps associated with each of the N keypoints. The spatial-domain keypoints describe an object boundary representation associated with the object included in the input image. The postprocessing module may also generate an arbitrary number of non-keypoint spatial-domain locations by sampling time-domain time steps on the interval [0,1) and performing inverse Fourier transform to generate spatial-domain locations associated with each of the sampled time steps. The spatial-domain keypoints and/or the sampled non-keypoint spatial-domain locations collectively describe an object boundary representation associated with the object included in the input image.

In some embodiments, the DNN model may include a multi-exit DNN machine learning model that includes multiple sequential layers. In these embodiments, earlier sequential layers included in the DNN model may predict Fourier coefficients associated with a relatively lower Fourier descriptor degree, e.g., K=7, while later sequential layers may predict Fourier coefficients associated with a relatively higher Fourier descriptor degree, e.g., K=200. In these embodiments, the trained DNN model may be deployed into multiple different computing environments having varying amounts of computing resources and/or varying requirements for accuracy and inference speed, e.g., real-time, near real-time, or offline modes of operation.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, imagery, and/or any other data described herein) may be used to determine boundaries for detected objects, and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., synthetic imagery depicting one or more objects from within the simulation. The synthetic training data (in addition to or alternatively from real-world data) may then be used or processed to test algorithms, systems, and/or processes for determining accurate object boundary representations.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to perform object boundary representation functions that may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAS, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, object detection, object boundary representation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, object boundary detection models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### System Overview

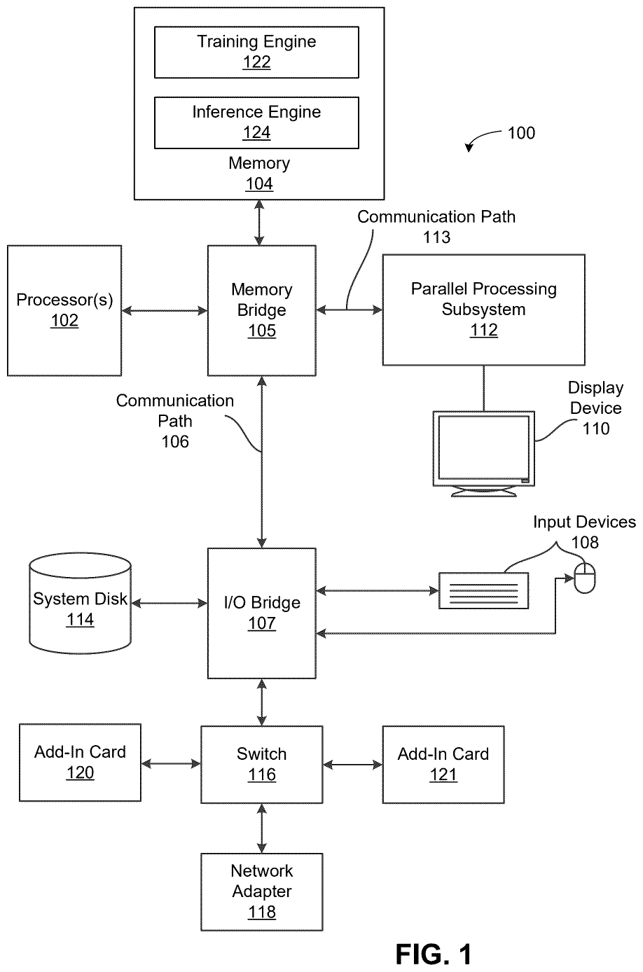

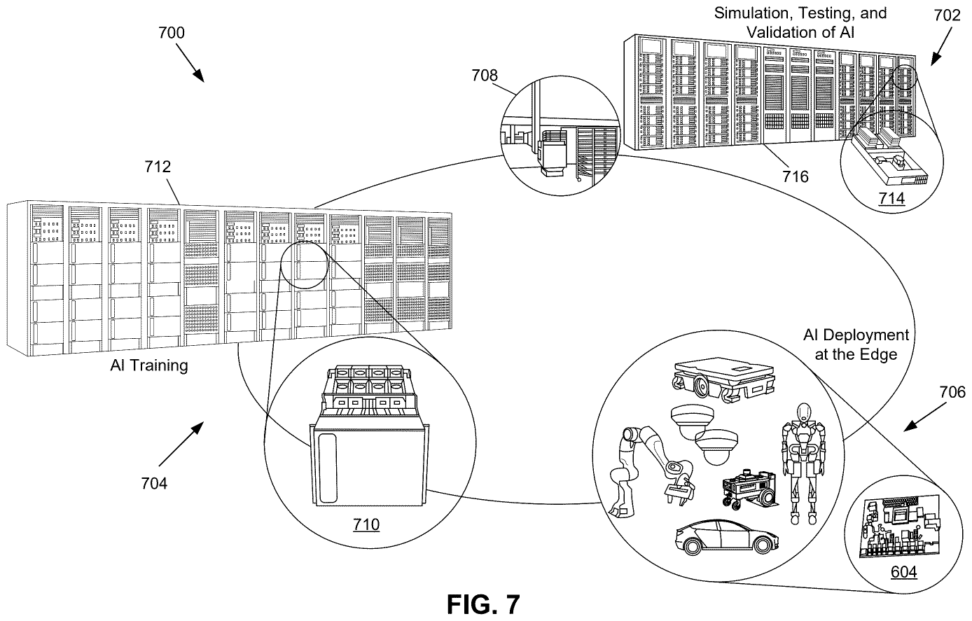

With reference to FIG. 1, FIG. 1 is a block diagram illustrating a computing system 100 configured to implement one or more aspects of at least one embodiment of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 600 of FIGS. 6A-6E, example computing ecosystem 700 of FIG. 7, and/or example computing device 800 of FIG. 8.

In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point to point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include a training engine 122 or an inference engine 124, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a PCI Express link, in which dedicated lanes are allocated to each PPU. Other communication paths may also be used, such as NVIDIA's NVLink. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add in cards 120, 121 would connect directly to I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 600 of FIGS. 6A-6E and/or example computing device 800 of FIG. 8.

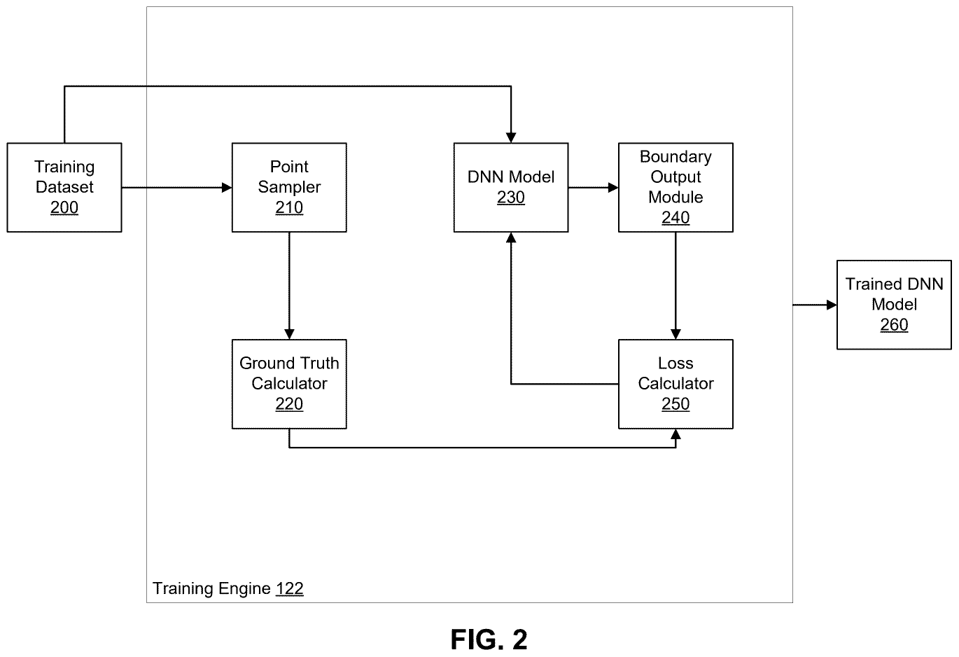

With reference to FIG. 2, FIG. 2 is a more detailed illustration of training engine 122 of FIG. 1, according to various embodiments. Training engine 122 generates trained DNN model 260 based on ground truth image and object boundary representation data included in training dataset 200. Training engine 122 includes, without limitation, point sampler 210, ground truth calculator 220, DNN model 230, boundary output module 240, and loss calculator 250.

In at least one embodiment, training dataset 200 includes one or more two-dimensional (2D) images, where each 2D image depicts one or more objects. At least one object included in each of the 2D images may be associated with a ground truth object boundary representation. A boundary representation may define a portion of an object that is visible in a 2D image. Examples of objects may include—but are not limited to—vehicles, roadway markings, pedestrians, parking spaces, signs, poles, or other stationary and/or moving objects.

In at least one embodiment, an object boundary representation may include N spatial-domain keypoints defining an N-sided polygon, where N is greater than or equal to three. For example, each of four spatial-domain keypoints may include complex coordinates defining the keypoint location within a 2D coordinate system associated with the 2D image, and the four keypoints may define the corners of a rectangular bounding polygon encompassing a depicted object, such as a rectangular street sign. In some techniques used to define ground truth object boundary representations, a keypoint may represent a corner of an object boundary representation, or may represent a region of significant curvature included in the ground truth object boundary representation.

In at least one embodiment, an object boundary representation may exhibit a circular or other elliptical shape, and may not include defined keypoints. In these embodiments, an elliptical shape may be defined as a series of points sampled from the perimeter of the elliptical shape. The points may be sampled uniformly, or by using any other suitable point sampling technique. These sampled points describe an elliptical object boundary representation without the use of keypoints, such that an elliptical object boundary representation may be considered to include zero keypoints. Training engine 122 receives the one or more 2D images included in training dataset 200 and transmits the one or more 2D images to point sampler 210. Training engine 122 may also transmit the 2D images to DNN model 230 described herein.

In at least one embodiment, point sampler 210 may sample one or more points included in a ground truth object boundary representation, based on a degree K associated with a Fourier descriptor to be learned by DNN model 230. Point sampler 210 may sample a quantity of points such that the sum of the number of keypoints included in a ground truth object boundary representation and the number of sampled points is greater than or equal to a quantity (2K+1). For example, given a specified Fourier descriptor degree K=6, the sum of the number of keypoints and the number of sampled points may be required to be at least (2(6)+1)=13. For a received ground truth object boundary representation including four keypoints, point sampler 210 may therefore be required to generate at least nine sampled points.

In at least one embodiment, point sampler 210 may determine a fixed number of spatial-domain points to sample between each adjacent pair of keypoints included in a ground truth object boundary representation, based on the required sum of keypoints and sampled points. For the above example of a rectangular ground truth object boundary representation having four keypoints, and a desired Fourier degree K=6, point sampler 210 may determine that it is necessary to generate three sampled points between each pair of adjacent keypoints. Point sampler 210 may therefore generate three sampled points associated with each of the four sides included in the rectangular ground truth object boundary representation. The twelve generated sampled points (three sampled points per side) and the four keypoints included in the object boundary representation collective comprise sixteen total points, which is more than sufficient for defining a Fourier descriptor of degree K=6 as discussed herein. As in this example, point sampler 210 may generate a greater number of sampled points than are necessary to satisfy the (2K+1) minimum number of total sampled points and keypoints.

In at least one embodiment, point sampler 210 may sample points along a ground truth object boundary representation such that the resulting collection of provided keypoints and sampled points are spaced evenly along the perimeter of the object boundary representation. In one or more embodiments, point sampler 210 may alternatively or additionally adjust the positions associated with sampled points based on, e.g., a distance between a pair of adjacent keypoints or an amount of direction change from one side of an object boundary representation to an adjacent side of the object boundary representation. For example, point sampler 210 may generate a number of relatively closely-spaced sampled points associated with two adjacent boundary sides that form a sharp corner, and may generate a number of relatively widely-spaced sampled points associated with two adjacent boundary sides that exhibit a small degree of angular change from the first boundary side to the second boundary side.

In at least one embodiment where a ground truth object boundary representation includes a circle or other elliptical shape having zero keypoints, point sampler 210 may generate one or more sampled points located between adjacent pairs of sampled points included in the ground truth object boundary representation, such as by calculating an average of the positions of the two adjacent sampled points. Alternatively or additionally, point sampler 210 may calculate a mathematical expression describing the circle or other elliptical shape, based on sampled points included in the ground truth object boundary representation. Point sampler 210 may then generate additional sampled points based on the calculated mathematical expression.

Point sampler 210 calculates a complex-valued representation for each spatial-domain keypoint included in the ground truth object boundary representation, as well as for each sampled point generated by point sampler 210. Accordingly, the entire object boundary may be represented as a complex function:

f(t)=x(t)+iy(t), Equation (1)
where t is in the range [0,1) and represents a progression in the time domain along the object boundary, beginning at a time step associated with a specified ground truth keypoint in the case of a polygonal object boundary, or at a specified ground truth sampled point in the case of an elliptical object boundary. In at least one embodiment, the specified beginning keypoint or sampled point may be defined as the left-most keypoint or sampled point in the object boundary. Point sampler 210 transmits the complex-valued representations of each of the keypoints and/or sampled points, as well as the quantity N of ground truth keypoints (if any) to ground truth calculator 220.

In at least one embodiment, ground truth calculator 220 generates at least 2K+1 ground truth coefficients associated with the K-degree Fourier descriptor to be learned by DNN model 230 described herein. Each of the ground truth coefficients ck includes both a real part and an imaginary part, and is generated using a Fourier transform:

$${c}_{k} = \frac{1}{M} {\sum }_{t = {t}_{0}}^{{t}_{M - 1}} f ( t ) ( cos ( - 2 π i k t ) + i sin ( - 2 π i k t ) ) , \qquad Equation ( 2 )$$

where M represents the combined total number of keypoints and sampled points, and t₀ to t^{M-1} are the time steps associated with each point. In at least one embodiment, a time step associated with a keypoint or sampled point refers to a relative position of the keypoint or sampled point along a perimeter of a ground truth object boundary representation, rather than a temporal value. For example, given a ground truth object boundary representation that includes four uniformly spaced keypoints and/or sampled points, the time steps associated with the four points may include t=0, t=¼, t= 2/4, and t=¾. Ground truth calculator 220 transmits the at least 2K+1 ground truth coefficients Ck to loss calculator 250. Ground truth calculator 220 may also store the quantity N of keypoints included in the ground truth object boundary representation. In at least one embodiment, ground truth calculator 220 may also store the quantity N of keypoints included in the ground truth object boundary representation.

In at least one embodiment, DNN model 230 includes a Deep Neural Network (DNN) that takes an image of a detected object as input and predicts Fourier coefficients associated with a K-degree Fourier descriptor. DNN model 230 may also predict a quantity N defining a number of uniformly spaced keypoints included in an object boundary representation described by the Fourier descriptor. In an alternative embodiment, DNN model 230 may also predict individual time steps associated with each of a quantity N of non-uniformly spaced keypoints included in an object boundary representation.

In at least one embodiment, DNN model 230 predicts a quantity (2K+1) complex-valued Fourier coefficients associated with the K-degree Fourier descriptor. As a complex-valued Fourier coefficient includes both a real component and an imaginary component, DNN model 230 therefore predicts a total of 2*(2K+1) numerical values.

The desired Fourier descriptor degree K may be empirically determined, based on a desired use case. For example, a Fourier descriptor degree K=7 may be suitable for deployment on an autonomous or semi-autonomous vehicle, robot, and/or other machine type 600, an example of which is described with respect to FIGS. 6A-6E. These use cases may include limited compute resources, and may prioritize real-time or near real-time inference over accuracy. Other use cases, such as data mining and/or pseudo labeling, may prioritize accuracy over inference speed and may include a relatively greater amount of compute resources, such as dedicated local and/or cloud-based servers. In these use cases, DNN model 230 may be trained to generate Fourier coefficients associated with a larger Fourier descriptor degree K, e.g., K=100, K=150, or K=200.

In at least one embodiment, training engine 122 may train a DNN model 230 that includes a multi-exit DNN machine learning model. In an embodiment where DNN model 230 includes a multi-exit DNN having multiple sequential layers, earlier sequential layers included in DNN model 230 may predict Fourier coefficients associated with a relatively lower Fourier descriptor degree, e.g., K=7, while later sequential layers may predict Fourier coefficients associated with a relatively higher Fourier descriptor degree, e.g., K=200. In these embodiments, DNN model 230 may be deployed after training into multiple different computing environments having varying amounts of computing resources and/or varying requirements for accuracy and inference speed, e.g., real-time, near real-time, or offline modes of operation.

In at least one embodiment, DNN model 230 predicts Fourier coefficients and a quantity N of uniformly spaced object boundary representation keypoints, based on an input image of an object. DNN model 230 transmits the predicted Fourier coefficients and the predicted quantity N to boundary output module 240. In an alternative embodiment where DNN model 230 predicts a quantity N of non-uniformly spaced object boundary representation keypoints, DNN model 230 also predicts time steps associated with each of the N non-uniformly spaced object boundary representation keypoints, and transmits the predicted time steps to boundary output module 240.

In at least one embodiment, boundary output module 240 generates a spatial-domain object boundary representation associated with the object image presented as input to DNN model 230, based on the Fourier coefficients and quantity N of keypoints predicted by DNN model 230. Based on the quantity N of keypoints predicted by DNN model 230, boundary output module 240 may generate a circular or other elliptical object boundary representation including zero keypoints, or a polygonal object boundary representation including three or more keypoints.

In an instance where DNN model 230 predicts a nonzero quantity N of uniformly spaced keypoints, boundary output module 240 may generate spatial-domain, complex-valued keypoint coordinates for each of the N uniformly spaced keypoints using an inverse Fourier transform:

$$x ( t ) + i y ( t ) = {\sum }_{k = - K}^{K} ( {c}_{k} \cdot real + {ic}_{k} \cdot imag ) * cos ( 2 π i k t ) + sin ( 2 π i kt ) , \qquad Equation ( 3 )$$

$$where t = 0 , 1 / N , 2 / N , … , ( N - 1 ) / N .$$

In an instance where DNN model 230 predicts a nonzero quantity N of non-uniformly spaced keypoints, boundary output module 240 may generate spatial-domain, complex-valued keypoint coordinates for each of the N non-uniformly spaced keypoints using the inverse Fourier transform given by Equation (3). In this instance, the values for t are determined by the N time steps t=S₀, S₁, . . . , S(_{N-1}) predicted by DNN model 230 and associated with the predicted N keypoints.

In an instance where DNN model 230 predicts a quantity N=0 keypoints, boundary output module 240 may perform an inverse Fourier transform given by Equation (3) to generate a predetermined number of non-keypoint spatial locations included in the object boundary representation. For example, boundary output module 240 may perform the inverse Fourier transform at each of, e.g., 25, 50, or 100 uniformly spaced time steps to generate a corresponding quantity of spatial domain, complex-valued sampled points along the object boundary representation. Although none of the sampled points represent keypoints, the sampled points collectively describe a circular or other elliptical boundary representation associated with the detected object provided as input to DNN model 230.

In at least one embodiment, boundary output module 240 transmits the generated object boundary representation to loss calculator 250, where the generated object boundary representation may include three or more keypoints or, in the case of a circular or other elliptical object boundary representation, the predetermined number of sampled non-keypoint spatial locations. Boundary output module 240 may also transmit the predicted quantity of keypoints N, the calculated time steps associated with a number of uniformly spaced keypoints, or the predicted time steps associated with a number of non-uniformly spaced keypoints to loss calculator 250.

In at least one embodiment, loss calculator 250 evaluates one or more training loss functions based on the values received from boundary output module 240 and the values received from ground truth calculator 220. Training engine 122 may iteratively modify one or more adjustable parameters included in DNN model 230 based on the one or more evaluated loss functions.

A training loss function included in loss calculator 250 may include a term to minimize the distance between the ground truth spatial-domain object boundary representation and the object boundary representation generated by boundary output module 240. Loss calculator 250 may also include a training loss function term that penalizes a difference between a ground truth quantity of spatial-domain keypoints and a quantity of spatial-domain keypoints predicted by DNN model 230. An additional training loss function term may penalize differences between ground truth Fourier coefficients and Fourier coefficients predicted by DNN model 230. In at least one embodiment, loss calculator 250 may include one or more standard object detection loss functions including—but not limited to—an intersection over union loss, a classification loss, a set prediction loss, and/or a center-ness loss.

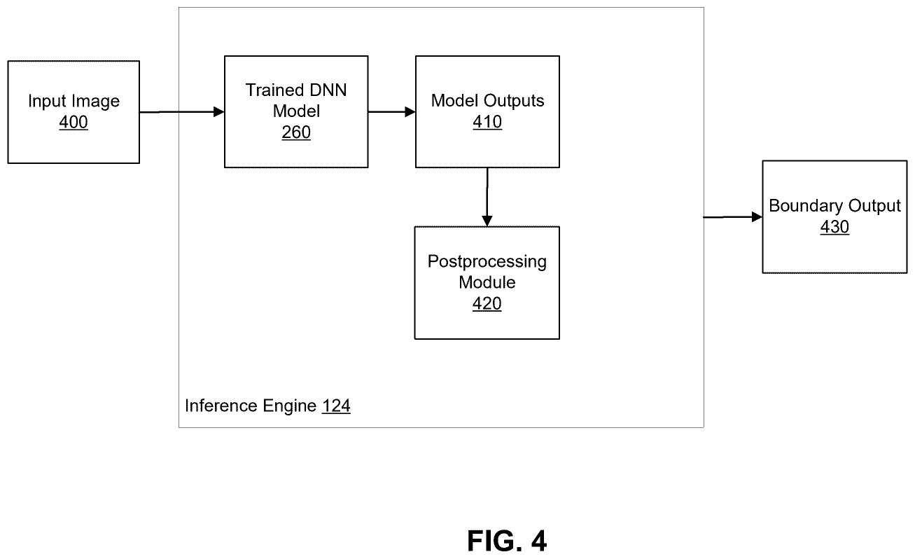

In at least one embodiment, training engine 122 iteratively modifies one or more adjustable parameters included in DNN model 230 based on the one or more loss function values computed by loss calculator 250. Training engine 122 may modify DNN model 230 during a predetermined number of iterations, or until one or more loss values computed by loss calculator 250 are below one or more predetermined thresholds. Training engine 122 generates trained DNN model 260 based on modified DNN model 230. Trained DNN model 260 is discussed in greater detail in the description of FIG. 4 herein.

It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 600 of FIGS. 6A-6E, and/or example computing device 800 of FIG. 8.

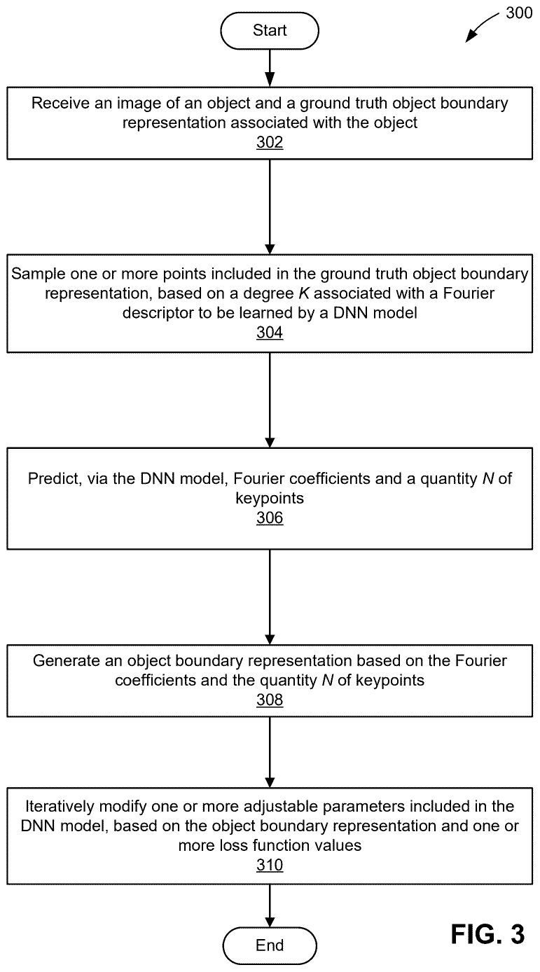

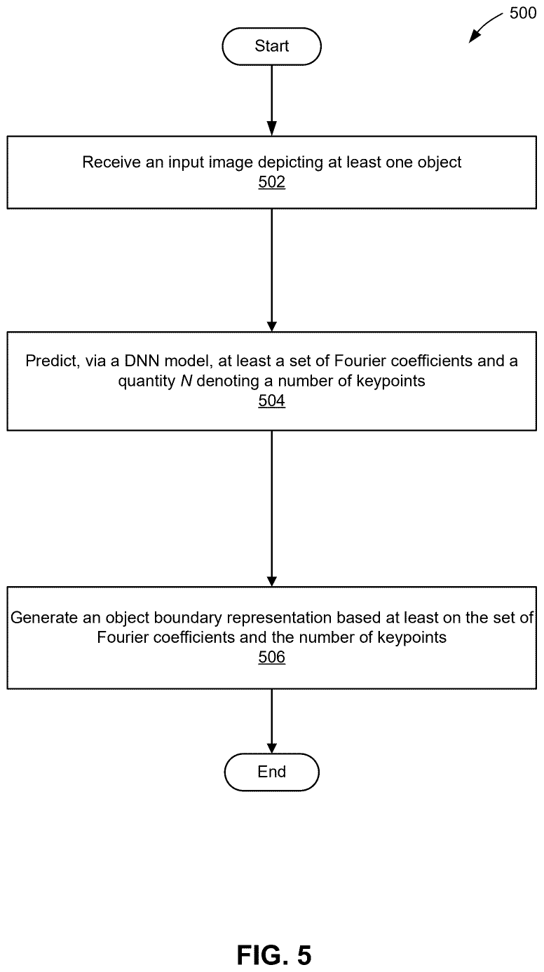

Now referring to FIGS. 3 and 5, each block of methods 300 or 500, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, methods 300 and 500 described, by way of example, with respect to FIGS. 1, 2, and/or 4. However, these methods may additionally or alternatively be executed by any one system, or any combination of systems, including, but not limited to, those described herein.

FIG. 3 is a flow diagram showing a method 300 for training a machine learning model, in accordance with some embodiments of the present disclosure. The method 300, at block 302, may include training engine 122 receiving an image of an object and a ground truth object boundary representation associated with the object. In at least one embodiment, training dataset 200 includes one or more 2D images, where each 2D image depicts one or more objects.

At least one object included in each of the 2D images may be associated with a ground truth object boundary representation that defines a portion of an object that is visible in a 2D image. In at least one embodiment, an object boundary representation may include N spatial-domain keypoints defining an N-sided polygon, where N is greater than or equal to three. In some techniques used to define ground truth object boundary representations, a keypoint may represent a corner of an object boundary representation, or may represent a region of significant curvature included in the ground truth object boundary representation.

In at least one embodiment, an object boundary representation may exhibit a circular or other elliptical shape, and may not include defined keypoints. In these embodiments, an elliptical shape may be defined as a series of points sampled from the perimeter of the elliptical shape. The points may be sampled uniformly, or by using any other suitable point sampling technique. These sampled points describe an elliptical object boundary representation without the use of keypoints, such that an elliptical object boundary representation may be considered to include zero keypoints. Training engine 122 receives the one or more 2D images included in training dataset 200 and transmits the one or more 2D images to point sampler 210. Training engine 122 may also transmit the 2D images to DNN model 230 described herein.

At block 304, point sampler 210 of training engine 122 may sample one or more points included in a ground truth object boundary representation, based on a degree K associated with a Fourier descriptor to be learned by a Deep Neural Network (DNN) model. Point sampler 210 may sample a quantity of points such that the sum of the number of keypoints included in a ground truth object boundary representation and the number of sampled points is greater than or equal to a quantity (2K+1). For example, given a specified Fourier descriptor degree K=6, the sum of the number of keypoints and the number of sampled points may be required to be at least (2(6)+1)=13. For a received ground truth object boundary representation including four keypoints, point sampler 210 may therefore be required to generate at least nine sampled points.

In at least one embodiment, point sampler 210 may sample points along a ground truth object boundary representation such that the resulting collection of provided keypoints and sampled points are spaced evenly along the perimeter of the object boundary representation. In one or more embodiments, point sampler 210 may alternatively or additionally adjust the positions associated with sampled points based on, e.g., a distance between a pair of adjacent keypoints or an amount of direction change from one side of an object boundary representation to an adjacent side of the object boundary representation.

In at least one embodiment where a ground truth object boundary representation includes a circle or other elliptical shape having zero keypoints, point sampler 210 may generate one or more sampled points located between adjacent pairs of sampled points included in the ground truth object boundary representation, such as by calculating an average of the positions of the two adjacent sampled points. Alternatively or additionally, point sampler 210 may calculate a mathematical expression describing the circle or other elliptical shape, based on sampled points included in the ground truth object boundary representation. Point sampler 210 may then generate additional sampled points based on the calculated mathematical expression.

Point sampler 210 calculates a complex-valued representation for each spatial-domain keypoint included in the ground truth object boundary representation, as well as for each sampled point generated by point sampler 210. Accordingly, the entire object boundary may be represented as a complex function, as in Equation (1) described herein.

In at least one embodiment, the specified beginning keypoint or sampled point may be defined as the left-most keypoint or sampled point in the object boundary. Point sampler 210 transmits the complex-valued representations of each of the keypoints and/or sampled points, as well as the quantity N of ground truth keypoints (if any) to ground truth calculator 220.

At block 306, DNN model 230 of training engine 122 predicts at least a set of Fourier coefficients and a quantity N denoting a number of keypoints. In at least one embodiment, the N keypoints are uniformly spaced in the time domain, and the quantity N is therefore sufficient to subsequently calculate time-domain time steps associated with each of the N keypoints. In an alternative embodiment, the N keypoints are non-uniformly spaced in the time domain, and DNN model 230 may also predict time-domain time steps associated with each of the N keypoints.

DNN model 230 predicts a quantity (2K+1) complex-valued Fourier coefficients associated with the K-degree Fourier descriptor. As a complex-valued Fourier coefficient includes both a real component and an imaginary component, DNN model 230 predicts a total of 2*(2K+1) numerical values.

In at least one embodiment, training engine 122 may train a DNN model 230 that includes a multi-exit DNN machine learning model. In an embodiment where DNN model 230 includes a multi-exit DNN having multiple sequential layers, earlier sequential layers included in DNN model 230 may predict Fourier coefficients associated with a relatively lower Fourier descriptor degree, e.g., K=7, while later sequential layers may predict Fourier coefficients associated with a relatively higher Fourier descriptor degree, e.g., K=200.

In at least one embodiment, DNN model 230 predicts Fourier coefficients and a quantity N denoting a number of uniformly spaced object boundary representation keypoints, based on an input image of an object. DNN model 230 transmits the predicted Fourier coefficients and the predicted quantity N to boundary output module 240. In an alternative embodiment where DNN model 230 predicts a quantity N of non-uniformly spaced object boundary representation keypoints, DNN model 230 also predicts time-domain time steps associated with each of the N non-uniformly spaced object boundary representation keypoints, and transmits the predicted time steps to boundary output module 240.

At block 308, boundary output module 240 of training engine 122 generates an object boundary representation based on the predicted Fourier coefficients and the predicted number of keypoints N. Based on the quantity N of keypoints predicted by DNN model 230, boundary output module 240 may generate a circular or other elliptical object boundary representation including zero keypoints, or a polygonal object boundary representation including three or more keypoints.

In an instance where DNN model 230 predicts a nonzero quantity N of uniformly spaced keypoints, boundary output module 240 may generate spatial-domain, complex-valued keypoint coordinates for each of the N uniformly spaced keypoints using the inverse Fourier transform given by Equation (3) described herein.

In an instance where DNN model 230 predicts a nonzero quantity N of non-uniformly spaced keypoints, boundary output module 240 may generate spatial-domain, complex-valued keypoint coordinates for each of the N non-uniformly spaced keypoints using the inverse Fourier transform given by Equation (3). In this instance, the values for t are determined by the N time steps t=S₀, S₁, . . . , S(_{N-1}) predicted by DNN model 230 and associated with the predicted N keypoints.

In an instance where DNN model 230 predicts a quantity N=0 keypoints, boundary output module 240 may perform an inverse Fourier transform given by Equation (3) to calculate a predetermined number of non-keypoint spatial locations included in the object boundary representation. For example, boundary output module 240 may perform the inverse Fourier transform at each of, e.g., 25, 50, or 100 uniformly spaced time steps to generate a corresponding quantity of spatial domain, complex-valued sampled points along the object boundary representation. Although none of the sampled points represent keypoints, the sampled points collectively describe a circular or other elliptical boundary representation associated with the detected object provided as input to DNN model 230.

In at least one embodiment, boundary output module 240 transmits the generated object boundary representation to loss calculator 250, where the generated object boundary representation may include three or more keypoints or, in the case of a circular or other elliptical object boundary representation, the predetermined number of sampled non-keypoint spatial locations. Boundary output module 240 may also transmit the predicted quantity of keypoints N, the calculated time steps associated with a number of uniformly spaced keypoints, or the predicted time steps associated with a number of non-uniformly spaced keypoints to loss calculator 250.

At block 310, training engine 122 iteratively modifies one or more adjustable parameters included in DNN model 230, based on the object boundary representation and one or more calculated loss function values. In at least one embodiment, loss calculator 250 evaluates one or more training loss functions based on the values received from boundary output module 240 and ground truth values associated with images included in training dataset 200. Training engine 122 may iteratively modify one or more adjustable parameters included in DNN model 230 based on the one or more evaluated loss functions.

A training loss function included in loss calculator 250 may include a term to minimize the distance between the ground truth spatial-domain object boundary representation and the object boundary representation generated by boundary output module 240. Loss calculator 250 may also include a training loss function term that penalizes a difference between a ground truth quantity of keypoints and a quantity of keypoints predicted by DNN model 230. An additional training loss function term may penalize differences between ground truth Fourier coefficients and Fourier coefficients predicted by DNN model 230. In at least one embodiment, loss calculator 250 may include one or more standard object detection loss functions including—but not limited to—an intersection over union loss, a classification loss, a set prediction loss, and/or a center-ness loss.

In at least one embodiment, training engine 122 iteratively modifies one or more adjustable parameters included in DNN model 230 based on the one or more loss function values computed by loss calculator 250. Training engine 122 may modify DNN model 230 during a predetermined number of iterations, or until one or more loss values computed by loss calculator 250 are below one or more predetermined thresholds. Training engine 122 generates trained DNN model 260 based on modified DNN model 230.

FIG. 4 is a more detailed illustration of inference engine 124 of FIG. 1, according to various embodiments. In at least one embodiment, inference engine 124 receives input image 400 that includes a depiction of an object. Inference engine 124 generates boundary output 430 including an object boundary that describes an outline associated with the depicted object. Inference engine 124 includes—but is not limited to—trained DNN model 260, model outputs 410, and postprocessing module 420.

In at least one embodiment, input image 400 may include a two-dimensional (2D) depiction of one or more objects included in a three-dimensional (3D) scene. In an instance where input image 400 depicts more than one object, one of the objects included in input image 400 may have been previously identified using any suitable object detection and/or recognition technique. For example, a previously identified object included in input image 400 may be associated with a bounding polygon, a pixel-level binary mask, or other identification annotation. Inference engine 124 may select a portion of input image 400 including the previously identified object, based at least on the identification annotation. Inference engine 124 may transmit the portion of input image 400 to trained DNN model 260. In an instance where input image 400 includes a single object, inference engine 124 may transmit input image 400 to trained DNN model 260 without modification.

In at least one embodiment, trained DNN model 260 includes a trained instance of DNN model 230 discussed in the detailed description of FIG. 2 herein. Trained DNN model 260 includes a Deep Neural Network (DNN) that receives an image of a detected object as input and predicts Fourier coefficients associated with a K-degree Fourier descriptor. Trained DNN model 260 may also predict a quantity N defining a number of uniformly spaced time-domain keypoints included in an object boundary representation described by the Fourier descriptor. In an alternative embodiment, trained DNN model 260 may also predict individual time steps associated with each of a quantity N of non-uniformly spaced time-domain keypoints included in an object boundary representation described by the Fourier descriptor.

In at least one embodiment, trained DNN model 260 predicts a quantity (2K+1) complex-valued Fourier coefficients associated with the K-degree Fourier descriptor. As a complex-valued Fourier coefficient includes both a real component and an imaginary component, trained DNN model 260 therefore predicts a total of 2*(2K+1) numerical values associated with the predicted Fourier coefficients.

The desired degree K of the Fourier descriptor learned by trained DNN model 260 may be empirically determined, based on a desired use case. For example, a Fourier descriptor degree K=7 may be suitable for deployment on an autonomous or semi-autonomous vehicle, robot, and/or other machine type 600, an example of which is described with respect to FIGS. 6A-6E). These use cases may include limited compute resources, and may prioritize real-time or near real-time inference over accuracy. Other use cases, such as data mining and/or pseudo labeling, may prioritize accuracy over inference speed and may include a relatively greater amount of compute resources, such as dedicated local and/or cloud-based servers. In these use cases, DNN model 230 may be trained to generate Fourier coefficients associated with a larger Fourier descriptor degree K, e.g., K=100, K=150, or K=200.

In at least one embodiment, trained DNN model 260 may include a multi-exit DNN machine learning model. In an embodiment where trained DNN model 260 includes a multi-exit DNN having multiple sequential layers, earlier sequential layers included in trained DNN model 260 may predict Fourier coefficients associated with a relatively lower Fourier descriptor degree, e.g., K=7, while later sequential layers may predict Fourier coefficients associated with a relatively higher Fourier descriptor degree, e.g., K=200. In these embodiments, trained DNN model 260 may be deployed in multiple different computing environments having varying amounts of computing resources and/or varying requirements for accuracy and inference speed, e.g., real-time, near real-time, or offline modes of operation.

In at least one embodiment, trained DNN model 260 predicts Fourier coefficients and a quantity N of uniformly spaced time-domain keypoints, based on an input image of an object. Trained DNN model 260 transmits model outputs 410, including the predicted Fourier coefficients and the predicted quantity N, to postprocessing module 420. In an alternative embodiment where trained DNN model 260 predicts a quantity N of non-uniformly spaced tie-domain keypoints, trained DNN model 260 also predicts time steps associated with each of the N non-uniformly spaced time-domain keypoints, and includes the predicted time steps in model outputs 410 for transmission to postprocessing module 420.

As described herein, model outputs 410 may include a quantity (2K+1) of complex-valued Fourier coefficients predicted by trained DNN model 260 and associated with a K-degree Fourier descriptor. Model outputs 410 may also include a quantity N of predicted time-domain keypoints associated with an object included in input image 400. In at least one embodiment, the N predicted time-domain keypoints are uniformly spaced within the range (0,1], and the quantity N is therefore sufficient to determine time steps associated with each of the keypoints. In an alternative embodiment where trained DNN model 260 is operable to predict time-domain time steps associated with each of a quantity N of predicted keypoints, model outputs 410 may also include a time step associated with each of the predicted keypoints. Inference engine 124 transmits model outputs 410 to postprocessing module 420.

In at least one embodiment, postprocessing module 420 calculates spatial-domain keypoints and/or sampled points associated with an object boundary representation, based on at least model outputs 410. The calculated spatial-domain keypoints and/or sampled points collectively represent an object boundary representation associated with an object included in input image 400.

Based on the quantity N of keypoints predicted by trained DNN model 260, postprocessing module 420 may generate a circular or other elliptical object boundary representation including zero keypoints, or a polygonal object boundary representation including three or more keypoints.

In an instance where trained DNN model 260 predicts a nonzero quantity N of uniformly spaced keypoints, postprocessing module 420 may calculate spatial-domain, complex-valued keypoint coordinates for each of the N uniformly spaced keypoints using the inverse Fourier transform given by Equation (3) described herein.

In an instance where trained DNN model 260 predicts a nonzero quantity N of non-uniformly spaced keypoints, postprocessing module 420 may calculate spatial-domain, complex-valued keypoint coordinates for each of the N non-uniformly spaced keypoints using the inverse Fourier transform given by Equation (3). In this instance, the values for t are determined by the N time steps t=S₀, S₁, . . . , S(_{N-1}) predicted by trained DNN model 260 and associated with the predicted N keypoints.

In an instance where trained DNN model 260 predicts a quantity N=0 keypoints, postprocessing module 420 may repeatedly perform the inverse Fourier transform given by Equation (3) to sample a predetermined number of non-keypoint spatial locations included in the object boundary representation. For example, postprocessing module 420 may perform the inverse Fourier transform at, e.g., 25, 50, or 100 uniformly spaced time steps to generate a corresponding quantity of spatial domain, complex-valued sampled points along the object boundary representation. Although none of the sampled points represent keypoints, the sampled points collectively describe a circular or other elliptical boundary representation associated with the object included in input image 400.

In at least one embodiment, postprocessing module 420 may calculate a predetermined number of sampled non-keypoint spatial locations in addition to calculating spatial locations associated with the nonzero quantity N keypoints predicted by trained DNN model 260. For example, in an instance where trained DNN model 260 predicts N=7 keypoints, postprocessing module 420 may calculate spatial locations associated with the seven keypoints, as well as calculating, e.g., 25, 50, or 100, sampled non-keypoint spatial locations. Postprocessing module 420 is operable to calculate an arbitrary number of non-keypoint spatial locations, based on the Fourier descriptor learned by trained DNN model 260 and the selection of an arbitrary number of time-domain time steps within the interval (0,1]. Inference engine 124 generates boundary output 430 based on the spatial-domain keypoints and/or sampled points calculated by postprocessing module 420.

In at least one embodiment, boundary output 430 includes multiple spatial domain keypoints and/or sampled non-keypoint spatial locations calculated by postprocessing module 420. The spatial domain keypoints and/or non-keypoint spatial locations collectively define an object boundary representation associated with an object included in input image 400. The number of spatial-domain keypoints N predicted by trained DNN model 260 is independent of the degree K of the Fourier descriptor learned by trained DNN model 260. Likewise, as described herein, the number of sampled non-keypoint spatial locations calculated by postprocessing module 420 is independent of both the number of spatial-domain keypoints N predicted by trained DNN model 260 and the degree K of the Fourier descriptor learned by trained DNN model 260. Inference engine 124 may transmit boundary output 430 to any number of downstream software and/or hardware applications for subsequent processing.

FIG. 5 is a flow diagram showing a method 500 for generating a boundary representation, in accordance with some embodiments of the present disclosure. The method 500, at block 502, may include receiving input image 400 depicting at least one object. In an instance where input image 400 depicts more than one object, one of the objects included in input image 400 may have been previously identified using any suitable object detection and/or recognition technique. Inference engine 124 may select a portion of input image 400 including the previously identified object, and transmit the portion of input image 400 to trained DNN model 260. In an instance where input image 400 includes a single object, inference engine 124 may transmit input image 400 to trained DNN model 260 without modification.

At block 504, trained DNN model 260 of inference engine 124 predicts at least a set of Fourier coefficients and a quantity N denoting a number of keypoints. In at least one embodiment, trained DNN model 260 includes a trained instance of DNN model 230 discussed in the detailed description of FIG. 2 herein. Trained DNN model 260 receives an image of a detected object as input and predicts Fourier coefficients associated with a K-degree Fourier descriptor to be learned by trained DNN model 260. Trained DNN model 260 may also predict a quantity N denoting a number of uniformly spaced time-domain keypoints included in an object boundary representation described by the Fourier descriptor. In an alternative embodiment, trained DNN model 260 may also predict individual time-domain time steps associated with each of a quantity N of non-uniformly spaced time-domain keypoints included in an object boundary representation described by the Fourier descriptor.

In at least one embodiment, trained DNN model 260 predicts a quantity (2K+1) complex-valued Fourier coefficients associated with the K-degree Fourier descriptor. The desired degree K of the Fourier descriptor learned by trained DNN model 260 may be empirically determined, based on a desired use case. For example, a Fourier descriptor degree K=7 may be suitable for deployment on an autonomous or semi-autonomous vehicle, robot, and/or other machine type 600, an example of which is described with respect to FIGS. 6A-6E). These use cases may include limited compute resources, and may prioritize real-time or near real-time inference over accuracy. Other use cases, such as data mining and/or pseudo labeling, may prioritize accuracy over inference speed and may include a relatively greater amount of compute resources, such as dedicated local and/or cloud-based servers. In these use cases, DNN model 230 may be trained to generate Fourier coefficients associated with a larger Fourier descriptor degree K, e.g., K=100, K=150, or K=200.

In at least one embodiment, trained DNN model 260 may include a multi-exit DNN machine learning model. In an embodiment where trained DNN model 260 includes a multi-exit DNN having multiple sequential layers, earlier sequential layers included in trained DNN model 260 may predict Fourier coefficients associated with a relatively lower Fourier descriptor degree, e.g., K=7, while later sequential layers may predict Fourier coefficients associated with a relatively higher Fourier descriptor degree, e.g., K=200. In these embodiments, trained DNN model 260 may be deployed in multiple different computing environments having varying amounts of computing resources and/or varying requirements for accuracy and inference speed, e.g., real-time, near real-time, or offline modes of operation.

In at least one embodiment, trained DNN model 260 predicts Fourier coefficients and a quantity N of uniformly spaced time-domain keypoints, based on an input image of an object. Trained DNN model 260 transmits model outputs 410, including the predicted Fourier coefficients and the predicted quantity N, to postprocessing module 420. In an alternative embodiment where trained DNN model 260 predicts a quantity N of non-uniformly spaced tie-domain keypoints, trained DNN model 260 also predicts time steps associated with each of the N non-uniformly spaced time-domain keypoints, and includes the predicted time steps in model outputs 410 for transmission to postprocessing module 420.

At block 506, postprocessing module 420 of inference engine 124 generates boundary output 430, including an object boundary representation based at least on the set of Fourier coefficients and the number of keypoints. Postprocessing module 420 calculates spatial-domain keypoints and/or sampled points associated with an object boundary representation, based on at least model outputs 410. The calculated spatial-domain keypoints and/or sampled points collectively represent an object boundary representation associated with an object included in input image 400.

Based on the quantity N of keypoints predicted by trained DNN model 260, postprocessing module 420 may generate a circular or other elliptical object boundary representation including zero keypoints, or a polygonal object boundary representation including three or more keypoints.

In an instance where trained DNN model 260 predicts a nonzero quantity N of uniformly spaced keypoints, postprocessing module 420 may calculate spatial-domain, complex-valued keypoint coordinates for each of the N uniformly spaced keypoints using the inverse Fourier transform given by Equation (3) described herein.

In an instance where trained DNN model 260 predicts a nonzero quantity N of non-uniformly spaced keypoints, postprocessing module 420 may calculate spatial-domain, complex-valued keypoint coordinates for each of the N non-uniformly spaced keypoints using the inverse Fourier transform given by Equation (3). In this instance, the values for t are determined by the N time steps t=S₀, S₁, . . . , S(_{N-1}) predicted by trained DNN model 260 and associated with the predicted N keypoints.

In an instance where trained DNN model 260 predicts a quantity N=0 keypoints, postprocessing module 420 may repeatedly perform the inverse Fourier transform given by Equation (3) to sample a predetermined number of non-keypoint spatial locations included in the object boundary representation. For example, postprocessing module 420 may perform the inverse Fourier transform at, e.g., 25, 50, or 100 uniformly spaced time-domain time steps to generate a corresponding quantity of spatial domain, complex-valued sampled points along the object boundary representation. Although none of the sampled points represent keypoints, the sampled points collectively describe a circular or other elliptical boundary representation associated with the object included in input image 400.

In at least one embodiment, postprocessing module 420 may calculate a predetermined number of sampled non-keypoint spatial locations in addition to calculating spatial locations associated with the nonzero quantity N keypoints predicted by trained DNN model 260. For example, in an instance where trained DNN model 260 predicts N=7 keypoints, postprocessing module 420 may calculate spatial locations associated with the seven keypoints, as well as calculating, e.g., 25, 50, or 100, sampled non-keypoint spatial locations. Postprocessing module 420 is operable to calculate an arbitrary number of non-keypoint spatial locations, based on the Fourier descriptor learned by trained DNN model 260 and the selection of an arbitrary number of time-domain time steps within the interval (0,1]. Inference engine 124 generates boundary output 430 based on the spatial-domain keypoints and/or sampled points calculated by postprocessing module 420.

In at least one embodiment, boundary output 430 includes multiple spatial domain keypoints and/or sampled non-keypoint spatial locations calculated by postprocessing module 420. The spatial domain keypoints and/or non-keypoint spatial locations collectively define an object boundary representation associated with an object included in input image 400. The number of spatial-domain keypoints N predicted by trained DNN model 260 is independent of the degree K of the Fourier descriptor learned by trained DNN model 260. Likewise, as described herein, the number of sampled non-keypoint spatial locations calculated by postprocessing module 420 is independent of both the number of spatial-domain keypoints N predicted by trained DNN model 260 and the degree K of the Fourier descriptor learned by trained DNN model 260. Inference engine 124 may transmit boundary output 430 to any number of downstream software and/or hardware applications for subsequent processing.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 6A is an example of sensor locations having corresponding fields of view or sensory fields for an autonomous or semi-autonomous vehicle 600A, an autonomous mobile robot (AMR) 600B, and a humanoid robot 600C, in accordance with some embodiments of the present disclosure. Although three types of machines 600 are illustrated, this is not intended to be limiting, and the machine(s) 600 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 600A, AMR 600B, humanoid robot 600C, and/or other machine types may be referred to herein collectively as machine 600, in some instances.

With respect to vehicles 600A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 600 may be capable of functionality in accordance with one or more of Level 3-Level 5 of the autonomous driving levels. The machine 600 may be capable of functionality in accordance with one or more of Level 1-Level 5 of the autonomous driving levels. For example, the machine 600 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 600 or other machine, such as being fully autonomous, being highly autonomous, being conditionally autonomous, being partially autonomous, providing assistive autonomy, being semi-autonomous, being primarily autonomous, or other designation.

With respect to FIG. 6A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 668D, a 180 degree field of view of a wide-view camera 670, a 360 degree sensory field of a LiDAR sensor 664, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 600A, AMR 600B, and/or humanoid robot 600C, etc. For example, with respect to the vehicle 600A, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 600B and/or humanoid robot 600C, the shape, size, purpose, implementation, model, etc. may dictate the number and types of sensors used.

As illustrated in FIG. 6A, the autonomous or semi-autonomous vehicle 600A, the AMR 600B, and the humanoid robot 600C may include different sensor types, number, and locations. For a non-limiting example, the vehicle 600A may include twelve cameras 668, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 664 may use, in embodiments, a gigabit multimedia serial link (GMSL) interface—such as GMSL2—as input/output (I/O).

In some embodiments, although not illustrated in FIG. 6A, the vehicle 600A may include an in-cabin occupant and/or driver monitoring system, that may include various different sensors. For example, the in-cabin sensors may include various cameras 668, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 668, the internal camera(s) 668 may, in embodiments, use a GMSL (such as GMSL2) interface for I/O.

As another non-limiting example, the vehicle 600A may further include nine RADAR sensors 660. For example, the vehicle 600A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 660 may use, in embodiments, an Ethernet interface as I/O.

The vehicle(s) 600A may further include, as a non-limiting example, twelve ultrasonic sensors 662. As illustrated in FIG. 6A, the ultrasonic sensors may be positioned along the front and rear bumpers of the vehicle 600A, and along the side of the vehicle 600A, and may be used to detect objects (static and dynamic) in close proximity to the vehicle 600A. In some embodiments, the ultrasonic sensor(s) 662 may use a DS13 interface as I/O.

The vehicle(s) 600A may further include, as a non-limiting example, a LiDAR sensor 664, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 664 may include a 360 degree horizontal FOV or sensory field (such as in a spinning LiDAR sensor) and a 90 degree vertical FOV or sensory field. In some embodiment, the LiDAR sensor(s) 664 may use an Ethernet interface as I/O.

The autonomous mobile robot (AMR) 600B may include, as a non-limiting example, three LiDAR sensors 664. For example, the top-most illustrated LiDAR sensor 664 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 600B may further include, as a non-limiting embodiment, eight cameras 668, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 600B may further include a charging port, charging port contacts, a status indicator light, one or more (e.g., four) RGB LEDs, one or more IMU sensors 666, a magnetometer, and a barometer. The AMR 600B is capable of high-precision time synchronization between sensors using hardware time stamping, and PTP over Ethernet with less than 10 microseconds for sensor acquisition time. The AMR 600B provides simultaneous camera capture across all cameras 668 within 100 microseconds from a single hardware trigger, in embodiments, and can write to disk at 4 GB/second for sensor capture to bag writing (e.g., writing to ROSbags for the robot operation system (ROS)). As such, the AMR 600B is capable of running the ROS (such as NVIDIA's Isaac ROS), can be teleoperated (as described herein), can map an environment, and can navigate within an environment using visual cameras 668, LiDARs 664, and/or other sensor types or modalities.

The humanoid robot 600C may include, as a non-limiting example, one LiDAR sensor 664. For example, the LiDAR sensor 664 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 600C may further include, as a non-limiting embodiment, four cameras 668, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 600C may further include, as a non-limiting embodiment, four ultrasonic sensors 662, such as a left arm ultrasonic sensor, a right arm ultrasonic sensor, a left leg ultrasonic sensor, and right leg ultrasonic sensor.

The humanoid robot 600C may further include any number of actuators—such as to allow control and maneuverability of joints. For example, the humanoid robot 600C may include actuators that allow for various degrees of freedom (DoF) depending on the design. In a non-limiting embodiment, the humanoid robot 600C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 600C may include position and orientation sensors, such as encoders, gyroscopes, and the like, to determine the position of the robot 600C in space, allowing for location determination and movement tracking. The humanoid robot 600C may include force and pressure sensors, in embodiments, to detect environment interactions, allowing the robot 600C to grasp objects with the right force and to avoid obstacles along the way. The perception sensors (e.g., cameras, LiDARs, RADARs, ultrasonic, SONAR, etc.) may be used along with tactile sensors to allow the robot 600C to perceive objects, shapes, and textures, and to understand when touch is initiated and stopped (along with force sensors that regulate the force used during touch). As a non-limiting example, the humanoid robot 600C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 600C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 600C may use onboard sensors, microphones, and speakers to understanding speech, audio and visual cues, etc., while also being able to communicate back to the environment.

With reference to cameras 668 of the machine(s) 600, the camera types for the cameras 668 may include, but are not limited to, digital cameras that may be adapted for use with the components and/or systems of the machine 600. For a vehicle 600A implementation, the camera(s) 668 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 600 (e.g., front-facing cameras) may be used for surround view, to help identify forward facing paths and obstacles, as well aid in, with the help of one or more controllers 636 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 668B that may be used to perceive objects coming into view from the periphery (e.g., pedestrians, warehouse vehicles, other robots, crossing traffic, or bicycles). In addition, any number of long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

Any number of stereo cameras 668A may also be included in a front-facing and/or other (e.g., rear-facing) configuration. In at least one embodiment, one or more of stereo camera(s) 668A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 600 environment, including a distance estimate for points in the image (e.g., a disparity or depth image). An alternative stereo camera(s) 668A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 600 (e.g., side-view cameras) may be used, for example, for surround view, providing information used to create and update the occupancy grid, as well as to generate side impact collision warnings and/or to indicate to an AMR 600B or humanoid robot 600C, for example, that there are objects, features, and/or persons present to the side. For example, surround camera(s) 668D may be positioned on the machine 600. The surround camera(s) 668D may include wide-view camera(s) 668B, fisheye camera(s), 360 degree camera(s), and/or the like. For example, four fisheye cameras may be positioned on the machine's 600 front, rear, and sides. In an alternative arrangement, the machine 600 may use three surround camera(s) 668D (e.g., left, right, and rear), and may leverage one or more other camera(s) (e.g., a forward-facing camera) as a fourth surround view camera.

Cameras 668 with a field of view that include portions of the environment to the rear of the machine 600 (e.g., rear-view cameras) may be used for gaining an understanding of objects, features, persons, and/or other information to the rear of the machine 600, such as for park assistance, surround view, rear collision warnings, planning, control, and navigation determinations, and/or creating and updating an occupancy grid, BEV image representing the environment, height map, etc. A wide variety of cameras 668 may be used including, but not limited to, cameras 668 that are also suitable as a front-facing camera(s) (e.g., long-range and/or mid-range camera(s) 698, stereo camera(s) 668A), infrared camera(s) 672, etc.), rear-facing camera(s), side-facing camera(s), downward facing camera(s), upward facing camera(s), and/or the like, as described herein.

Similarly, for LiDAR sensors 664, RADAR sensors 660, ultrasonic sensors 662, and/or other sensor modalities or types, the location and placement of the sensors, and their corresponding fields of view or sensory fields may be determined based on the use case, implementation, or design of the particular machine 600.

For example, the machine(s) 600 include RADAR sensor(s) 660 that may be used by the machine 600 for long-range object detection, even in darkness and/or severe weather conditions. RADAR functional safety levels may be ASIL B, in embodiments. The RADAR sensor(s) 660 may use the CAN and/or the bus 602 (e.g., to transmit data generated by the RADAR sensor(s) 660) for control and to access object tracking data, with access to Ethernet to access raw data in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 600 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 660 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 600 (e.g., vehicle, robot, etc.). As such, short-range RADAR systems may be used in an ADAS system for blind spot detection and/or lane change assist.

The machine 600 may further include ultrasonic sensor(s) 662. The ultrasonic sensor(s) 662, which may be positioned at the front, back, and/or the sides of the machine 600, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 600. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B, as an example.

The machine 600 may include LiDAR sensor(s) 664. The LiDAR sensor(s) 664 may be used for object and feature detection, pedestrian and other robot detection, emergency braking, collision avoidance, simultaneous localization and mapping (SLAM), free-space detection, and/or other functions. The LiDAR sensor(s) 664 may be functional safety level ASIL B, in embodiments. In some examples, the machine 600 may include multiple LiDAR sensors 664 (e.g., two, four, six, etc.) that may use Ethernet (e.g., to provide data to a Gigabit Ethernet switch).

In some examples, the LiDAR sensor(s) 664 may be capable of providing a list of objects and their distances for a 360-degree field of view. Commercially available LiDAR sensor(s) 664 may have an advertised range of approximately 600 m, with an accuracy of 2 cm-3 cm, and with support for a 600 Mbps Ethernet connection, for example. In some examples, one or more non-protruding LiDAR sensors 664 may be used. In such examples, the LiDAR sensor(s) 664 may be implemented as a small device that may be embedded into the front, rear, sides, top, and/or corners of the machine 600. The LiDAR sensor(s) 664, in such examples, may provide up to a 120-degree horizontal and 35-degree vertical field-of-view, with a 200 m range even for low-reflectivity objects. Front-mounted LiDAR sensor(s) 664 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 600. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 664 may be less susceptible to motion blur, vibration, and/or shock.

FIG. 6B is an illustration of sensor and component locations of an example autonomous or semi-autonomous vehicle 600A (alternatively referred to herein as “vehicle 600,” “ego-vehicle 600,” “ego-machine 600,” or “machine 600,”), in accordance with some embodiments of the present disclosure. Although the vehicle 600A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 6C is a block diagram of an example system architecture for a machine 600, such as autonomous or semi-autonomous vehicle 600A, autonomous mobile robot (AMR) 600B, humanoid robot 600C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 600 of FIGS. 6A-6E, example computing ecosystem 700 of FIG. 7, and/or example computing device 800 of FIG. 8.

Each of the components, features, and systems of the machine 600 in FIG. 6C are illustrated as being connected via bus 602 (alternatively referred to as a “machine communications network 602,” or just “communications network 602”). The bus 602 may include a Controller Area Network (CAN) data interface (alternatively referred to herein as a “CAN bus”). A CAN may be a network inside the machine 600 used to aid in control of various features and functionality of the machine 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 602 may include FlexRay, an embedded bus (e.g., SPI, I2C), local interconnect link (LIN), NVIDIA's NVLink, ultra accelerator Link (UALink), USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the machine 600, and two or more busses 602 may communicate with the same components. In some examples, each SoC 604, each controller 636, and/or each computer or compute engine within the machine 600 may have access to the same input data (e.g., inputs from sensors of the machine 600), and may be connected to a common bus, such as a CAN bus.

The machine 600 may include components such as a chassis, a vehicle body, wheels (e.g., 2, 4, 6, 8, 18, etc.), tires, axles, batteries, side-view mirrors, and/or other components of a vehicle or machine. The machine 600 may include a propulsion system 650, such as an internal combustion engine, hybrid electric power plant, an all-electric engine, a hydrogen-fueled engine, and/or another propulsion system type. The propulsion system 650 may be connected to a drive train of the machine 600, which may include a transmission, to enable the propulsion of the machine 600. The propulsion system 650 may be controlled in response to receiving signals from the throttle/accelerator 652.

A steering system 654, which may include a steering wheel and/or other steering device (e.g., remote steering and/or local steering), may be used to steer the machine 600 (e.g., along a desired path or route) when the propulsion system 650 is operating (e.g., when the vehicle is in motion). The steering system 654 may receive signals from a steering actuator 656. In some embodiments, a steering wheel or other steering mechanism may not be included, such as for a machine 600 capable of full automation (e.g., Level 5) functionality.

The brake sensor system 646 may be used to operate the vehicle brakes in response to receiving signals from the brake actuators 648 and/or brake sensors.

The machine 600 may include one or more controller(s) 636, such as those described herein with respect to FIG. 6A. The controller(s) 636 may be used for a variety of functions, and may be coupled to any of the various other components and systems of the machine 600. For example, the controllers 636 may be used for control of the machine 600, artificial intelligence executing on the machine 600, infotainment for the machine 600, and/or the like. For example, one controller 636 may be used for some or all of the functionality, or different controllers 636 may be used for different functionalities—e.g., to ensure availability and a safety separation between various controllers for different tasks. For example, the controller(s) 636 may use plans computed by the system—e.g., paths or trajectories for vehicles 600A or AMRs 600B, or movements, components trajectories, movement locations or displacements, etc. for joints or components (e.g., of manipulators, end effectors, limbs, hands, fingers, legs, feet, etc.), of a humanoid robot 600C—to control the machine(s) 600 in the environment. In some instances, the controller(s) 636 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 600C, for example, the controller(s) 636 may act as the brain, responsible for analyzing sensor data, making decisions, and sending commands to the actuators. The controller(s) 636 may include a low-level controller that handles basic motor control, ensuring accurate and precise movements of individual joints and actuators. The controller(s) 636 may include a high-level controller to coordinate multiple actuators and sensors, planning complex motions and adapting to changing environments.

The controller(s) 636 may include an artificial intelligence controller, in embodiments, that may use AI algorithms (e.g., DNNs, MLMs, etc.) to learn, make decisions, and autonomously perform tasks for the machine 600. In some embodiments, the controller(s) 636 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 636 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 636, which may include one or more systems on chip (SoCs) 604 (FIGS. 6C and 6D), CPUs, GPU(s), accelerator(s), etc., may provide signals (e.g., representative of commands or messages) to one or more components and/or systems of the machine 600. Although the controller(s) 636 is listed separately from the SoC(s) 604, this is not intended to be limiting, and in some embodiments one or more components of the SoC(s) 604 may perform the operations of the controller(s) 636. For example, the controller(s) may send signals to operate the machine brakes via one or more brake actuators 648, to operate the steering system 654 via one or more steering actuators 656, to operate the propulsion system 650 via one or more throttle/accelerators 652, etc. The controller(s) 636 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 600. The controller(s) 636 may include a first controller 636 for autonomous control and navigation functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 636 may handle two or more of the above functionalities, two or more controllers 636 may handle a single functionality, and/or any combination thereof.

The controller(s) 636 may provide the signals for controlling one or more components and/or systems of the machine 600 in response to sensor data received from one or more sensors (e.g., sensor inputs). The sensor data may be received from, for example and without limitation, global navigation satellite systems (“GNSS”) sensor(s) 658 (e.g., Global Positioning System sensor(s)), RADAR sensor(s) 660, ultrasonic sensor(s) 662, LiDAR sensor(s) 664, inertial measurement unit (IMU) sensor(s) 666 (e.g., accelerometer(s), gyroscope(s), magnetic compass(es), magnetometer(s), etc.), microphone(s) 696, camera(s) 668 (e.g., stereo camera(s) 668A, wide-view camera(s) 668B (e.g., fisheye cameras), infrared camera(s) 672, surround camera(s) 668D (e.g., 360 degree cameras), long-range and/or mid-range camera(s) 698, and/or other camera types), speed sensor(s) 644 (e.g., for measuring the speed of the machine 600), vibration sensor(s) 642, steering sensor(s) 640, brake sensor(s) (e.g., as part of the brake sensor system 646), actuators, and/or other sensor types.

One or more of the controller(s) 636 may receive inputs (e.g., represented by input data) from an instrument cluster 632 of the machine 600 and provide outputs (e.g., represented by output data, display data, etc.) via a human-machine interface (HMI) display 634 (e.g., screen, heads-up display, mirror display, facial display, robotic display, etc.), an audible annunciator, a loudspeaker, a speaker, and/or via other components of the machine 600. The outputs may include information such as machine velocity, speed, time, map data corresponding to a map(s) 622 of FIG. 6C (e.g., from a navigation map, a Standard Definition (SD) map, a High Definition (“HD”) map, etc.), location data (e.g., the machine's 600 location, such as on a map 622), direction, location of other vehicles (e.g., an occupancy map, height map, bird's eye view (BEV) image, grid, etc.), information about objects and status of objects as perceived by the system, system status information, etc. For example, the HMI display(s) 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 600 may include one or more systems on a chip (SoCs) 604 (described in more detail in FIG. 6D). The SoC(s) 604 may include CPU(s) 606, GPU(s) 608, processor(s) 610, cache(s) 612, accelerator(s) 614, data store(s) 616, and/or other components and features. The SoC(s) 604 may be used to process and provide data for various operations, such as navigation, planning, reasoning, inference, perception, control, and/or actuation operations of the machine 600 in a variety of platforms and systems. For example, the SoC(s) 604 may process live perception data (e.g., from camera, LiDAR, RADAR, ultrasonic, etc.) in addition to map data corresponding to one or more maps 622 (e.g., HD map, SD map, navigational map, occupancy map, etc.) in order to make or aid in performing various operations of the machine 600. Where a map and/or AI is used, map and/or AI (e.g., model parameter updates, fine-tuning, etc.) refreshes and/or updates via a network interface 624 from one or more servers (e.g., server(s) 678 of FIG. 6E)—such as one or more servers of a cloud-based data center.

Although an SoC(s) 604 is illustrated throughout FIGS. 6A-6E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 600, use of the machine 600, model of the machine 600, and required capabilities of the machine 600, one or more SoCs 604 and/or alternative architectures and/or components may be used to satisfy the particular implementation.

The machine 600 may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The machine 600 may include a GPU(s) 620 (e.g., discrete GPU(s), or dGPU(s)), that may be coupled to the SoC(s) 604 via a high-speed interconnect (e.g., NVIDIA's NVLink, ultra accelerator Link (UALink), etc.). The GPU(s) 620 may provide additional artificial intelligence functionality, such as by executing redundant and/or different neural networks, and may be used to train and/or update neural networks based on input (e.g., sensor data) from sensors of the machine 600.

The machine 600 may further include the network interface 624 which may include one or more wireless antennas 626 and/or modems (e.g., one or more wireless antennas for different communication protocols, such as a cellular antenna, a Bluetooth antenna, etc.). The network interface 624 may be used to enable wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 600 information about vehicles in proximity to the machine 600 (e.g., vehicles in front of, on the side of, and/or behind the machine 600). This functionality may be part of a cooperative adaptive cruise control functionality of the machine 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 626 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 600 may further include data store(s) 628 which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The machine 600 may further include GNSS sensor(s) 658. The GNSS sensor(s) 658 (e.g., GPS, assisted GPS sensors, differential GPS (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The machine 600 may further include IMU sensor(s) 666. The IMU sensor(s) 666 may be located at a center of the rear axle of the machine 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may enable the machine 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include one or more microphone 696 placed in and/or around the machine 600. The microphone(s) 696 may be used for emergency vehicle detection and identification, among other things.

The machine 600 may further include vibration sensor(s) 642. The vibration sensor(s) 642 may measure vibrations of components of the machine, such as the arms or legs of a humanoid robot 600C, or the axle(s) of a vehicle 600A or AMR 600B. For example, changes in vibrations may indicate a change in road, walking, or traversable surfaces. In another example, when two or more vibration sensors 642 are used, the differences between the vibrations may be used to determine friction or slippage of the surface (e.g., when the difference in vibration is between a power-driven axle and a freely rotating axle).

The machine 600 may include an ADAS system 638—such as when the machine 600 is a vehicle 600A. The ADAS system 638 may include a dedicated SoC(s), in some examples. The ADAS system 638 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 600 may further include the infotainment SoC 630 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 600. For example, the infotainment SoC 630 may radios, disk players, navigation systems, video players, USB and Bluetooth connectivity, carputers, in-car entertainment, Wi-Fi, steering wheel audio controls, hands free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the machine 600. In some examples, the infotainment SoC 630 may be coupled to a supervisory MCU such that the GPU of the infotainment system may perform some self-driving functions in the event that the primary controller(s) 636 (e.g., the primary and/or backup computers of the machine 600) fail. In such an example, the infotainment SoC 630 may put the machine 600 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 600—whether a vehicle 600A, AMR 600B, humanoid robot 600C, and/or other type of machine—may include a locally stored language model(s) and/or communicate to a remotely hosted language model (e.g., via one or more APIs) to provide more detailed and in-depth communication features to the users of the machine(s) 600.

In some examples, an infotainment SoC 630, the SoC(s) 604, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 600. The always on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 600.

The machine 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. In other words, the instrument cluster 632 may be included as part of the infotainment SoC 630, or vice versa.

FIG. 6D is a block diagram of an example architecture of a computing system (a subset of the system described with respect to FIG. 6C), in accordance with at least some embodiments of the present disclosure. Although illustrated as an SoC(s) 604, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 604 may be an end-to-end platform with a flexible architecture that spans automation levels 2-5, or the SoC(s) 604 may be specifically designed for a specific automation level (e.g., a first SoC 604 for level 2 to level 2++, a second SoC 604 for level 3, a third SoC 604 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 2-5 autonomous vehicles as well as for safe planning, navigation, and control of AMRs 600B, humanoid robots 600C, and/or other robot or machine types.

In some embodiments, such as where the SoC(s) 604 include a GPU 608 with 2000 or more cores (e.g., 2048 cores), 60 or more tensor cores (e.g., 64 tensor cores), and a GPU max frequency of over 1 GHz (e.g., 1.3 GHZ), a CPU 606 including 10 or more cores (e.g., 12 cores), with 64 bits, 3 MB L2 and 6 MB L3 cache memory, and a max frequency of 2 or more GHz (e.g., 2.2 GHZ), one or more deep learning accelerators (DLAs), deep learning accelerator clusters (XNNs), neural network accelerators (NNAs), or neural processing units (NPUs) 609 (e.g., 2 DLAs/XNNs/NNAs/NPUs 609), and a vision accelerator—such as a programmable vision accelerator (PVA) 607, a single SoC 604) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 604 include a GPU 608 with 1700 or more cores (e.g., 1792 cores), 50 or more tensor cores (e.g., 56 tensor cores), and a GPU max frequency of over 900 MHz (e.g., 930 MHz), a CPU 606 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 609 (e.g., 2 DLAs/XNNs/NNAs/NPUs 609), and a vision accelerator—such as a programmable vision accelerator (PVA) 607, a single SoC 604) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 604 include a GPU 608 with 1000 or more cores (e.g., 1024 cores), 28 or more tensor cores (e.g., 32 tensor cores), and a GPU max frequency of over 900 MHz (e.g., 1173 MHz), a CPU 606 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 609 (e.g., 1 DLA/XNN/NNA/NPU 609), and a vision accelerator—such as a programmable vision accelerator (PVA) 607, a single SoC 604) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 604 include a GPU 608 with 1000 or more cores (e.g., 1024 cores), 28 or more tensor cores (e.g., 32 tensor cores), and a GPU max frequency of over 900 MHz (e.g., 1020 MHz), a CPU 606 including 6 or more cores (e.g., 6 cores), with 64 bits, 1.5 MB L2 and 4 MB L3 cache memory, and a max frequency of 1.5 or more GHz (e.g., 1.7 GHZ), a single SoC 604) may be capable of 67 tera operations per second (TOPS) of AI performance. For example, NVIDIA's Jetson Orin Nano 8 GB SoC satisfies these criteria, and achieves this performance.

The SoC(s) 604 may include one or more CPUs 606. The CPU(s) 606 may include a CPU cluster or CPU complex (alternatively referred to herein as a “CCPLEX”), in embodiments. The CPU(s) 606 may include multiple cores and/or (e.g., L2, L3) caches. For example, in some embodiments, the CPU(s) 606 may include twelve cores in a coherent multi-processor configuration. In some embodiments, the CPU(s) 606 may include four dual-core clusters where each cluster has a dedicated L2 cache (e.g., a 3 MB L2 cache). The CPU(s) 606 (e.g., the CCPLEX) may be configured to support simultaneous cluster operation enabling any combination of the clusters of the CPU(s) 606 to be active at any given time.

The SoC(s) 604 may include any type and number of GPUs 608. For example, an integrated GPU(s) (alternatively referred to herein as an “iGPU(s)”) may be used in some embodiments. The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive, robotics, and/or other embedded use cases. For example, the GPU(s) 608 may be fabricated on a Fin field-effect transistor (FinFET). However, this is not intended to be limiting and the GPU(s) 608 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

The SoC(s) 604 may include any number of cache(s) 612, including those described herein. For example, the cache(s) 612 may include L0 caches, L1 caches, L2 caches, L3 caches (e.g., that are available to both the CPU(s) 606 and the GPU(s) 608 (e.g., that is connected both the CPU(s) 606 and the GPU(s) 608)), etc. The cache(s) 612 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 604 may include one or more arithmetic logic units (ALUs) 665 which may be leveraged in performing processing with respect to any of the variety of tasks or operations of the machine 600—such as computer vision, machine learning or deep learning processing, world model management, etc. In addition, the SoC(s) 604 may include a floating point unit(s) (FPU(s)) 667—or other math coprocessor or numeric coprocessor types—for performing mathematical operations within the system. For example, the SoC(s) 604 may include one or more FPUs 667 integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory 615 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 614 (e.g., the hardware acceleration cluster) may include a deep learning accelerator(s) (DLA) 609 (alternatively referred to herein as “a deep learning accelerator cluster (XNN) 609,” “neural network accelerator (NNA) 609,” or “neural processing unit (NPU) 609”). The DLA(s) 609 may include one or more Tensor processing units (TPUs) 641 that may be configured to provide an additional, e.g., ten trillion operations per second for deep learning applications and inferencing. The TPUs 641 may be accelerators configured to, and optimized for, performing image processing functions (e.g., for CNNs, RCNNs, DNNs, etc.). The DLA(s) 609 may further be optimized for a specific set of neural network types and floating point operations, as well as inferencing. The design of the DLA(s) may provide more performance per millimeter than a general-purpose GPU, and vastly exceeds the performance of a CPU. The TPU(s) 641 may perform several functions, including a single-instance convolution function, supporting, for example, INT8, INT16, and FP16 data types for both features and weights, as well as post-processor functions. Although the TPU(s) 641 are described as being included as part of the DLA(s) 609, this is not intended to be limiting, and the TPU(s) 641 may be included in additional or alternative accelerator(s) 614 and/or other components, and/or may be included as a discrete processing component(s).

The DLA(s) 609 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 609 may perform any function of the GPU(s) 608, and by using an inference accelerator, for example, a designer may target either the DLA(s) 609 or the GPU(s) 608 for any function. For example, the designer may focus processing of DNNs and floating point operations on the DLA(s) 609 and leave other functions to the GPU(s) 608 and/or other accelerator(s) 614. The DLA(s) 609 may be used to run any type of network to enhance control and safety, including for example, a neural network that outputs a measure of confidence for each object detection.

The accelerator(s) 614 (e.g., the hardware acceleration cluster) may include a programmable vision accelerator(s) (PVA) 607, which may alternatively be referred to herein as a computer vision accelerator or generally a vision accelerator. The PVA(s) 607 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 607 may provide a balance between performance and flexibility. For example, each PVA(s) 607 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 607 may be optimized for the tasks of image processing and computer vision algorithm acceleration. For example, the PVA(s) 607 provides excellent performance with extremely low power consumption, and can be used asynchronously and concurrently with the CPU(s) 606, GPU(s) 608, and/or other accelerators in the system (e.g., vehicle, robot, etc.) as part of a heterogeneous compute pipeline.

The PVA(s) 607 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 643 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 606 (e.g., ARM Cortex-R5 processor), facilitating data exchange with the CPU(s) 606 and other system-level components. The VPU I-cache may supply instruction data to the VPU(s) when requested, may request missing instruction data from system memory, and/or may maintain temporary instruction storage for the VPU. For each VPU task, the CPU(s) 606 may configures the DMA system, optionally prefetch the VPU program into VPU I-cache, and/or kick off each VPU-DMA pair to process a task. The PVA(s) 607 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 607 to access the system memory independently of the CPU(s) 606. The DMA may support any number of features used to provide optimization to the PVA(s) 607 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 607 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 607, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 607 may be configured to employ data parallelism. For example, in some embodiments, the plurality of vector processors included in a single PVA(s) 607 may execute the same computer vision algorithm, but on different regions of an image. In other examples, the vector processors included in a particular PVA(s) 607 may simultaneously execute different computer vision algorithms, on the same image, or even execute different algorithms on sequential images or portions of an image. Among other things, any number of PVAs 607 may be included in the hardware acceleration cluster and any number of vector processors may be included in each of the PVAs. In addition, the PVA(s) 607 may include additional error correcting code (ECC) memory, to enhance overall system safety.

The accelerator(s) 614 (e.g., the hardware accelerator cluster) have a wide array of uses for autonomous and semi-autonomous machine control. The PVA(s) 607 may be a programmable vision accelerator that may be used for key processing stages in perception, robotics understanding and reasoning, ADAS, semi-autonomous, and autonomous vehicles, etc. The PVA's 607 capabilities are a good match for algorithmic domains needing predictable processing, at low power and low latency. In other words, the PVA(s) 607 performs well on semi-dense or dense regular computation, even on small data sets, which need predictable run-times with low latency and low power. Thus, in the context of platforms for autonomous vehicles and robotics, the PVAs 607 are designed to run classic computer vision algorithms, as they are efficient at object detection and operating on integer math.

For example, according to one embodiment of the technology, the PVA 607 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 607 may perform computer stereo vision function on inputs from two monocular cameras.

In some examples, the PVA(s) 607 may be used to perform dense optical flow. According to process raw RADAR data (e.g., using a 4D Fast Fourier Transform) to provide Processed RADAR. In other examples, the PVA(s) 607 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 607, this is not intended to be limiting. In some embodiments, these components may be included in alternative or additional processing components and/or accelerator(s) 614, and/or may be included as discrete components of the SoC(s) 604 and/or other computing system architecture(s).

In some examples, the SoC(s) 604 may include a real-time ray-tracing hardware accelerator (RTA) 651 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 600 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 651 and/or a ray-tracing optimized GPU 606—such as NVIDIA's RTX GPU.

The accelerator(s) 614 (e.g., in the hardware acceleration cluster) may include one or more optical flow accelerators (OFAs) 611. For example, the OFA(s) 611 may be used for computing optical flow and stereo disparity between frames of sensor data (e.g., images). Optical flow may be accelerated on the OFA(s) 611 for uses such as object detection and tracking, and/or for stereo depth estimation where used for computing stereo disparity between stereo image frames (e.g., two or more frames captured using two or more image sensors with at least partially overlapping fields of view).

The SoC(s) 604 may include one or more camera serial interfaces (CSIs) 623. For example, the CSI(s) 623 may include a mobile industry processor interface (MIPI) camera serial interface (CSI) for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role. For example, the CSI 623 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 614 (e.g., the hardware acceleration cluster) may include a computer vision network on-chip (CVNOC) 663 and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by the PVA 607, OFA 611, DLA 609, and/or other accelerator(s) 614. Each pair of memory blocks may include an advanced peripheral bus (APB) interface, configuration circuitry, a controller, and a multiplexer. Any type of memory 615 may be used. The PVA 607, OFA 611, DLA 609, and/or other accelerator(s) 614 may access the memory via a backbone that provides the accelerator(s) 614 with high-speed access to memory. The backbone may include a computer vision network on-chip that interconnects the accelerator(s) 614 to the memory (e.g., using the APB).

The CVNOC 663 may include an interface that determines, before transmission of any control signal/address/data, that the accelerator(s) 614 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 604 may include data store(s) 616 and/or memory 615. The data store(s) 616 may be on-chip memory 615 of the SoC(s) 604, which may store neural networks and/or other algorithms to be executed on the CPU(s) 606, the GPU(s) 608, and/or one or more of the accelerator(s) 614. In some examples, the data store(s) 616 may be large enough in capacity to store multiple instances of neural networks for redundancy and safety. The data store(s) 612 may comprise L2 and/or L3 cache(s) 612, for example. The memory(ies) 615 may include SRAM, LPDDR5, and/or other memory types. For example, the memory(ies) 615 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 616 may include reference to the memory associated with the PVA 607, OFA 611, DLA 609, and/or other accelerator(s) 614, as described herein.

The data store(s) 616 may include various storage types, such as eMMC, NVMe, etc. For example, the SoC(s) 604 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 616 and/or other storage may be accessed via, e.g., NVMe, using PCI Express (PCIe), RDMA, TCP, and/or other protocols.

The SoC(s) 604 may include one or more processor(s) 610 (e.g., embedded processors). The processor(s) 610 may include a boot and power management processor (BPMP) 653, that may be a dedicated processor and subsystem to handle boot power and management functions and related security enforcement. The BPMP 653 may be a part of the SoC(s) 604 boot sequence and may provide runtime power management services. The BPMP 653 may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, accelerator(s) 614, and/or other components. If temperatures are determined to exceed a threshold, BPMP 653 may enter a temperature fault routine and put the SoC(s) 604 into a lower power state and/or put the machine 600 into a chauffeur to safe stop mode (e.g., bring the machine 600 to a safe stop).

The processor(s) 610 may further include a set of embedded processors that may serve as an audio processing engine (APE) 655. The APE 655 may be an audio subsystem that enables full hardware support for multi-channel audio over multiple interfaces, and a broad and flexible range of audio I/O interfaces. In some examples, the APE 655 is a dedicated processor core with a digital signal processor with dedicated RAM.

The processor(s) 610 may further include an always on processor engine (AOPE) 657 that may provide necessary hardware features to support low power sensor management and wake use cases. The AOPE 657 may include a processor core, a tightly coupled RAM, supporting peripherals (e.g., timers and interrupt controllers), various I/O controller peripherals, and routing logic.

The processor(s) 610 may further include a safety processor(s) 613 (alternatively referred to as “safety island 613”), which may include a safety cluster engine that includes a dedicated processor or processor subsystem to handle safety management for automotive, robotics, and/or other applications. The safety processor(s) 613—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 613 may include a discrete processor(s), such that fault of other system components may not impact the performance and availability of the safety processor 613.

The processor(s) 610 may further include a real-time or near real-time sensor engine (SE) 659 that may include a dedicated processor subsystem for handling real-time or near real-time camera, LiDAR, RADAR, and/or other sensor modality management.

The processor(s) 610 may further include one or more image signal processors (ISPs) 627, which may include a high-dynamic range signal processor and/or a hardware engine that is part of one or more sensor processing pipelines.

The processor(s) 610 may include a video image compositor (VIC) 661 that may be a processing block (e.g., implemented on a microprocessor) that implements video post-processing functions needed by a video playback application to produce the final image for the player window. The VIC 661 may perform lens distortion correction on wide-view camera(s) 668B, surround camera(s) 668D, in-cabin monitoring camera sensors, and/or other camera sensors with distorted fields of view.

A VIC 661 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 661 may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a broad range of peripheral interfaces for input/output (I/O) 625, such as to enable communication with peripherals, audio codecs, power management, and/or other devices. The SoC(s) 604 may be used to process data from cameras (e.g., connected over Gigabit Multimedia Serial Link and/or Ethernet), sensors (e.g., LiDAR sensor(s) 664, RADAR sensor(s) 660, etc. that may be connected over Ethernet), data from bus 602 (e.g., speed of machine 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks. In some embodiments, the SoC(s) 604 I/O 625 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 625 elements, components, or features.

The SoC(s) 604 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 604 may include an RJ45 connector with up to 10 GbE, a 1 GbE connector, and/or other networking connector types.

The SoC(s) 604 may include one or more digital signal processors (DSPs) 643. For example, the DSP(s) 643 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 604 may include one or more video encoders 619 and/or one or more video decoders 621. For example, the video encoder(s) 619 may include a hardware-based (e.g., as part of the GPU(s) 608) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 621 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 621 may be hardware-based (e.g., as part of the GPU(s) 608).

The SoC(s) 604 may include one or more general compute acceleration clusters (GCAC(s)) 629. For example, the GCAC(s) 629 may include various processor types that may be used to accelerate compute, such as one or more vector microcode processors (VMPs) 633, one or more multi-threaded processing clusters (MPCs) 631, one or more programmable macro arrays (PMA(s)) 635, and/or one or more other processor types. For example, the GCAC(s) 629 may include a PMA 635, two VMPs 633, and 2 MPCs 631.

The SoC(s) 604 may include one or more vector microcode processors (VMPs) 633. The VMP(s) 633, in embodiments, may include a wide vector (very long instruction word (VLIW) and single instruction multiple data (SIMD)) machine with performing various operations, such as short integral type operations common in computer vision and deep learning algorithms.

The SoC(s) 604 may include one or more multi-threaded processing clusters (MPCs) 631. The MPC(s) 631 may include a processing cluster that be, in embodiments, more versatile than a GPU, and with higher efficiency than a CPU. For example, the MPC(s) 631 may include a multi-threaded processor that allows multiple threads to share resources and execute instructions concurrently.

The SoC(s) 604 may include one or more programmable macro arrays (PMA(s)) 635. The PMA(s) 635 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 604 may include one or more display processing units (DPUs) 645 for performing hardware-accelerated image processing. For example, the DPU(s) 645 may retrieve pixel data from memory 615 and send it to a display peripheral through standard interfaces. As such, the DPU(s) 645 may handle display processing and rendering for in-machine and/or on-machine displays.

The SoC(s) 604 may include one or more application processing units (APUs) 639. For example, the APU(s) 639 may include a quad or dual-core processor with 48 KB/32 KB L1 cache with parity and ECC, along with a 1 MB L2 cache with ECC. The APU(s) 639 may support NEON instructions and single and double precision floating point operations.

The SoC(s) 604 may include one or more real-time processing units (RTPUs) 669. The RTPU(s) 669 may include a dual-core processor with 32 KB/32 KB L1 cache, and 256 KB TCM with ECC. The RTPU(s) 669 may support single and double precision floating point operations.

The SoC(s) 604 may include one or more built-in self-test (BIST) components 637. For example, the BIST component(s) 637 may include memory BIST (MBIST) to test memories of the system and/or logic BIST (LBIST) to test logic of the system. The BIST components 637 may include embedded logic for directly testing logic and/or memory of the system.

The SoC(s) 604 may include one or more dynamically reconfigurable processors (DRPs) 671. For example, the DRP(s) 671 may be used for accelerating various computing operations. For example, the DRP(s) 671 may be combined, in embodiments, with a MAC unit for use as an AI accelerator. In embodiments, the DRP(s) 671 may execute applications while dynamically switching the circuit connection configuration of the arithmetic units (e.g., ALUs) on the chip at each operating clock according to the content to be processed. Since only the necessary arithmetic circuits are used, the DRP(s) 671 may consume less power than with CPU processing and can achieve higher speed. Furthermore, compared to CPUs, where frequent external memory accesses due to cache misses and other causes will degrade performance, the DRP(s) 671 can build the necessary data paths in hardware ahead of time, resulting in less performance degradation and less variation in operating speed (jitter) due to memory accesses. The DRP(s) 671 may include a dynamic loading function that switches the circuit connection information each time the algorithm changes, enabling processing with limited hardware resources, even in robotic/automotive applications that require processing of multiple algorithms.

In some embodiments, the accelerator(s) 614 may include an OpenCV accelerator for speeding up processing of OpenCV, an open-source industry standard library for computer vision processing. In some embodiments, the combination of one or more DRP(s) 671 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 604 may include various compute engines (e.g., processors 610, CPUs 606, GPU(s) 608, accelerator(s) 614, etc.), tasks may be distributed between and among the compute engines, in some instances without common cause failures due to the discrete footprint of the compute engines. Further, because the SoC(s) 604 may include a dedicated safety processor(s) 613 (or safety island 613), critical safety or redundant operations may be performed without common cause failures from the main processing components or compute engines of the SoC(s) 614. Due to these features, the SoC(s) 604 and/or the underlying systems of the machine 600 may be capable of satisfying higher levels of safety—such as automotive safety integrity level (ASIL) D from the ISO 26262 standard.

FIG. 6E is a system diagram for communication between a cloud-based server(s) (e.g., in a data center, such as those described herein) and the example autonomous or semi-autonomous vehicle or machine 600 of FIG. 6A, in accordance with some embodiments of the present disclosure. The system 676 may include a server(s) 678, a network(s) 690, and a machine(s) 600. The server(s) 678 may include a plurality of GPUs 684(A)-684(H) (collectively referred to herein as GPUs 684), switches 682(A)-682(H) (such as PCIe 4.0/5.0/etc switches, M.2 slots, thunderbolt, USB4, NVIDIA's NVLink, NVIDIA's NVSwitch, GPUDirect RDMA, GPUDirect Storage, ultra accelerator Link (UALink), etc.), CPUs 680(A)-680(B) (collectively referred to herein as CPUs 680), accelerators, and/or other processor types. The GPUs 684, the CPUs 680, and the PCIe switches may be interconnected with high-speed interconnects such as, for example and without limitation, NVLink interfaces 688 developed by NVIDIA and/or PCIe connections 686 (and/or ultra accelerator Link (UALink)). In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the machine(s) 600, sensor data indicating information about new or previously unexplored locations, and/or sensor data indicating changes to previously seen/stored locations (e.g., unexpected or changed road conditions, such as recently commenced road-work). The server(s) 678 may transmit, over the network(s) 690 and to the machine(s) 600, neural networks 692, updated neural networks 692, map information 694, etc., including information regarding traffic and road conditions. The updates to the map information 694 may include updates for the HD map 622, SD map, navigation map, etc., such as information regarding construction sites, potholes, detours, flooding, and/or other obstructions. In some examples, the neural networks 692, the updated neural networks 692, the map information 694, and/or the other information may have resulted from new training and/or experiences represented in data received from any number of machine(s) 600 in the environment, and/or based on training performed at a datacenter (e.g., using the server(s) 678 and/or other servers).

The server(s) 678 may be used to train machine learning models (e.g., neural networks) based on training data. The training data may be generated by the machine(s) 600, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 600 (e.g., transmitted to the machine(s) 600 over the network(s) 690, and/or the machine learning models may be used by the server(s) 678 to remotely monitor and/or control the machine(s) 600.

In some examples, the server(s) 678 may receive data from the machine(s) 600 and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the machine 600. For example, the deep-learning infrastructure may receive periodic updates from the machine 600, such as a sequence of images and/or objects that the machine 600 has located in that sequence of images (e.g., via computer vision and/or other machine learning object classification techniques). The deep-learning infrastructure may run its own neural network to identify the objects and compare them with the objects identified by the machine 600 and, if the results do not match and the infrastructure concludes that the AI in the machine 600 is malfunctioning, the server(s) 678 may transmit a signal to the machine 600 instructing a fail-safe computer of the machine 600 to assume control, notify the passengers, and complete a safety maneuver or operation—such as to slow down, hand control back to a driver, come to a stop, and/or pull over/shut down.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 7 is a system diagram illustrating a three-computer ecosystem 700, including a first computing system 702 for generating or creating artificial intelligence (AI)—such as AI training and validation data, a second computing system 704 for training artificial intelligence, and a third computing system 706 (which may include or correspond to the SoC(s) 604 of FIGS. 6A-6E) deploying the AI at the edge, in accordance with at least some embodiments of the present disclosure. For example, to develop and deploy embodied or physical AI, the three-computer ecosystem 700 may be used, including three accelerated computer systems to handle physical AI training, simulation, and runtime (e.g., edge deployment). These systems may generate training data for and train multimodal foundation models (and/or other model types) using scalable, physically based simulations of the machine(s) 600 and their worlds. By doing so, simulation of machine(s) 600 may be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) 600 can perform safely in controlled settings.

The computing system 704 (e.g., NVIDIA's DGX Platform) may be used to train and fine-tune powerful foundation and generative AI models. Models, such as general-purpose foundation models (e.g., NVIDIA's Project GROOT), may be used to enable robots and other machine(s) 600 to understand natural language and emulate movements by observing human actions. The computing system 704 may include a platform that incorporates software, infrastructure, and expertise in a modern, unified AI development and training solution. The computing system 704 may include individual computing devices 710 (e.g., NVIDIA's DGX B200, H200, etc.) and/or any number of computing devices 710 in a data center infrastructure 712 (e.g., NVIDIA's DGX SuperPOD).

For example, the individual computing devices 710 may include GPUs (e.g., 8 GPUs with 1,440 GB total GPU memory) and CPUs (e.g., 2 CPUs with 112 cores total, 2.1 GHZ, or 4 GHz (with boost)) that provide upwards of 72 petaFLOPS for training and 144 petaFLOPS for inference. The computing devices 710 may include memory (e.g., 4 TB memory, and storage (e.g., OS storage of 2×1.9 TB NVMe M.2, and internal storage of 8×3.84 TB NVMe U.2). The computing devices 710 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 710 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 710 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 710 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 710 may include a smart host channel adapter (HCA) (e.g., NVIDIA's ConnectX-7) to provide ultra-low latency, 400 Gb/s throughput for in-network computing acceleration engines.

The data center infrastructure 712 may include any number of the computing devices 710, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 710) to thousands, job scheduling and orchestration to ensure hassle-free execution of every developer's job, AI workflow management and machine learning operations (MLOps) to move more models from prototype to production, and enterprise software to speed developer success.

The computing system 702 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 702 allows developers to use simulation frameworks to simulate and validate robot models, and/or to generate massive amounts of physically-based synthetic data to bootstrap model training. The computing system 702 may support learning frameworks that power robot reinforcement learning and imitation learning, to accelerate robot policy training and refinement. For example, the computing system 702 may be used to generate any number of simulations 708—such as within NVIDIA's OMNIVERSE. The computing system 702 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 702 may host or support a native OpenUSD software platform enabling enterprises to connect 3D pipelines and develop advanced, real-time 3D applications for industrial digitalization. With powerful ray-tracing-accelerated AI and graphics capabilities, the computing system 702 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 702 may include individual computing devices 714 (e.g., NVIDIA's OVX 1405 Server) and/or any number of computing devices 714 in a data center infrastructure 716 (e.g., NVIDIA's OVX Systems).

The computing device(s) 714 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 714 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 714 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 714 may include a smart host channel adapter (HCA) (e.g., NVIDIA's ConnectX-7) to provide ultra-low latency, 400 Gb/s throughput for in-network computing acceleration engines. The computing device(s) 714 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 712, the data center infrastructure 716 may allow for any number of computing device(s) 714 to be combined in cluster configuration according to a reference architecture.

The computing system 706 may be used to deploy trained AI models on a runtime computer—such as the SoC(s) 604 described herein. For example, these computing systems 706 may be designed for compact, on-board computing needs, including an ensemble of models for control policy, vision and language models, etc., deployed on a power-efficient on-board edge computing system 706. Details of components, features, and capabilities of the computing system 706 may be described in more detail herein with respect to FIGS. 6A-6E.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s), speaker(s), etc.), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLink, ultra accelerator Link (UALink), etc.) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Network Environments

Network environments suitable for use in implementing embodiments of the disclosure may include one or more client devices, servers, network-attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### EXAMPLE CLAUSES

1. In some embodiments, a system comprises one or more processors to receive a two-dimensional (2D) image depicting an object, predict, using a machine learning model, a quantity of time-domain keypoints, calculate a set of time-domain keypoints based at least on the predicted quantity and a set of Fourier coefficients associated with a Fourier descriptor, for each time-domain keypoint in the set of time-domain keypoints, calculate, based at least on the set of Fourier coefficients, the Fourier descriptor, and the time-domain keypoint, a spatial-domain keypoint associated with the time-domain keypoint, generate an object boundary representation associated with the depicted object based at least on the spatial-domain keypoints calculated for the set of time-domain keypoints, and perform one or more planning, control, or navigation operations associated with a machine based at least on the object boundary representation.

2. The system of clause 1, wherein the system is comprised in at least one of a control system for an autonomous or semi-autonomous machine, a perception system for an autonomous or semi-autonomous machine, a system for performing one or more simulation operations, a system for performing one or more digital twin operations, a system for performing light transport simulation, a system for performing collaborative content creation for 3D assets, a system for performing one or more deep learning operations, a system implemented using an edge device, a system implemented using a robot, a system for performing one or more generative AI operations, a system for performing operations using one or more large language model (LLMs), a system for performing operations using one or more vision language models (VLMs), a system for performing operations using one or more multi-modal language models (MMLMs), a system for performing operations using one or more vision-language-action (VLA) models, a system for using or deploying one or more inference microservices, a system for performing one or more conversational AI operations, a system for generating synthetic data, a system for presenting at least one of virtual reality content, augmented reality content, or mixed reality content, a system incorporating one or more virtual machines (VMs), a system implemented at least partially in a data center, or a system implemented at least partially using cloud computing resources.

3. The system of clauses 1 or 2, wherein the machine learning model includes a Deep Neural Network (DNN), and the DNN predicts the set of Fourier coefficients based at least on a degree associated with the Fourier descriptor.

4. The system of any of clauses 1-3, where the DNN includes a multi-exit DNN, and each of multiple layers included in the multi-exit DNN is operable to generate a different set of Fourier coefficients.

5. The system of any of clauses 1-4, wherein the set of calculated time-domain keypoints consists of an empty set including zero keypoints, and the one or more processors are further to generate a predetermined number of non-keypoint spatial locations included in the object boundary representation.

6. The system of any of clauses 1-5, wherein the generating the predetermined number of non-keypoint spatial locations is based at least on an inverse Fourier transform and one or more calculated time-domain time steps.

7. The system of any of clauses 1-6, wherein the object boundary representation includes a polygonal or elliptical boundary having a quantity of vertices equal to or greater than the predicted quantity of time-domain keypoints.

8. The system of any of clauses 1-7, wherein the set of time-domain keypoints are uniformly spaced in a time domain.

9. The system of any of clauses 1-8, wherein the set of time-domain keypoints are non-uniformly spaced in a time domain.

10. The system of any of clauses 1-9, further comprising predicting, using the machine learning model, a time-domain time step associated with each of the time-domain keypoints included in the set of time-domain keypoints.

11. In some embodiments, a method comprises receiving a two-dimensional (2D) image depicting an object, predict, using a machine learning model, a quantity of time-domain keypoints, calculating a set of time-domain keypoints based at least on the predicted quantity and a set of Fourier coefficients associated with a Fourier descriptor, for each time-domain keypoint in the set of time-domain keypoints, calculating, based at least on the set of Fourier coefficients, the Fourier descriptor, and the time-domain keypoint, a spatial-domain keypoint associated with the time-domain keypoint, and generating an object boundary representation associated with the depicted object, based at least on the spatial-domain keypoints calculated for the set of time-domain keypoints.

12. The method of clause 11, wherein the machine learning model includes a Deep Neural Network (DNN), and the DNN predicts the set of Fourier coefficients based at least on a degree associated with the Fourier descriptor.

13. The method of clauses 11 or 12, where the DNN includes a multi-exit DNN, and each of multiple layers included in the multi-exit DNN is operable to generate a different set of Fourier coefficients.

14. The method of any of clauses 11-13, wherein the set of calculated time-domain keypoints consists of an empty set including zero keypoints, and the method further comprises generating a predetermined number of non-keypoint spatial locations included in the object boundary representation.

15. The method of any of clauses 11-14, wherein the generating the predetermined number of non-keypoint spatial locations is based at least on an inverse Fourier transform and one or more calculated time-domain time steps.

16. The method of any of clauses 11-15, wherein the object boundary representation includes a polygonal or elliptical boundary having a quantity of vertices equal to or greater than the predicted quantity of time-domain keypoints.

17. The method of any of clauses 11-16, further comprising predicting, using the trained machine learning model, a time-domain time step associated with each of the time-domain keypoints included in the set of time-domain keypoints.

18. In some embodiments, an autonomous or semi-autonomous machine comprises one or more central processing units (CPUs), one or more graphics processing units (GPUs), one or more hardware accelerators, one or more sensors having fields of view or sensor fields external to the autonomous or semi-autonomous machine, wherein the autonomous or semi-autonomous machine is to perform one or more planning, navigation, or control operations based at least on an object boundary representation corresponding to an object in an image, the object boundary representation generated based at least on applying an inverse Fourier transform to a set of keypoints, wherein a number of keypoints to be included in the set of keypoints is computed based at least on a machine learning model processing image data corresponding to the image.

19. The autonomous or semi-autonomous machine of clause 18, wherein the one or more CPUs, the one or more GPUs, and the one or more hardware accelerators are comprised in one or more systems-on-a-chip (SoCs), and wherein a individual SoC of the one or more SoCs is capable of 275 tera operations per second (TOPS) of AI performance

20. The autonomous or semi-autonomous machine of clauses 18 or 19, wherein the autonomous or semi-autonomous machine includes or is associated with at least one of a control system for an autonomous or semi-autonomous machine, a perception system for an autonomous or semi-autonomous machine, a system for performing one or more simulation operations, a system for performing one or more digital twin operations, a system for performing light transport simulation, a system for performing collaborative content creation for 3D assets, a system for performing one or more deep learning operations, a system implemented using an edge device, a system implemented using a robot, a system for performing one or more generative AI operations, a system for performing operations using one or more large language model (LLMs), a system for performing operations using one or more vision language models (VLMs), a system for performing operations using one or more multi-modal language models (MMLMs), a system for performing operations using one or more vision-language-action (VLA) models, a system for using or deploying one or more inference microservices, a system for performing one or more conversational AI operations, a system for generating synthetic data, a system for presenting at least one of virtual reality content, augmented reality content, or mixed reality content, a system incorporating one or more virtual machines (VMs), a system implemented at least partially in a data center, or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A system comprising:
one or more processors to:
receive a two-dimensional (2D) image depicting an object;
predict, using a machine learning model, a quantity of time-domain keypoints;
calculate a set of time-domain keypoints based at least on the predicted quantity and a set of Fourier coefficients associated with a Fourier descriptor;
for each time-domain keypoint in the set of time-domain keypoints, calculate, based at least on the set of Fourier coefficients, the Fourier descriptor, and the time-domain keypoint, a spatial-domain keypoint associated with the time-domain keypoint;
generate an object boundary representation associated with the depicted object based at least on the spatial-domain keypoints calculated for the set of time-domain keypoints; and
perform one or more control or navigation operations associated with a machine based at least on the object boundary representation.

2. The system of claim 1, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

3. The system of claim 1, wherein the machine learning model includes a Deep Neural Network (DNN), and the DNN predicts the set of Fourier coefficients based at least on a degree associated with the Fourier descriptor.

4. The system of claim 3, where the DNN includes a multi-exit DNN, and each of multiple layers included in the multi-exit DNN is operable to generate a different set of Fourier coefficients.

5. The system of claim 1, wherein the set of calculated time-domain keypoints consists of an empty set including zero keypoints, and the one or more processors are further to generate a predetermined number of non-keypoint spatial locations included in the object boundary representation.

6. The system of claim 5, wherein the generating the predetermined number of non-keypoint spatial locations is based at least on an inverse Fourier transform and one or more calculated time-domain time steps.

7. The system of claim 1, wherein the object boundary representation includes a polygonal or elliptical boundary having a quantity of vertices equal to or greater than the predicted quantity of time-domain keypoints.

8. The system of claim 1, wherein the set of time-domain keypoints are uniformly spaced in a time domain.

9. The system of claim 1, wherein the set of time-domain keypoints are non-uniformly spaced in a time domain.

10. The system of claim 1, further comprising predicting, using the machine learning model, a time-domain time step associated with each of the time-domain keypoints included in the set of time-domain keypoints.

11. A method comprising:
receiving a two-dimensional (2D) image depicting an object;
predict, using a machine learning model, a quantity of time-domain keypoints;
calculating a set of time-domain keypoints based at least on the predicted quantity and a set of Fourier coefficients associated with a Fourier descriptor;
for each time-domain keypoint in the set of time-domain keypoints, calculating, based at least on the set of Fourier coefficients, the Fourier descriptor, and the time-domain keypoint, a spatial-domain keypoint associated with the time-domain keypoint; and
generating an object boundary representation associated with the depicted object, based at least on the spatial-domain keypoints calculated for the set of time-domain keypoints.

12. The method of claim 11, wherein the machine learning model includes a Deep Neural Network (DNN), and the DNN predicts the set of Fourier coefficients based at least on a degree associated with the Fourier descriptor.

13. The method of claim 12, where the DNN includes a multi-exit DNN, and each of multiple layers included in the multi-exit DNN is operable to generate a different set of Fourier coefficients.

14. The method of claim 11, wherein the set of calculated time-domain keypoints consists of an empty set including zero keypoints, and the method further comprises generating a predetermined number of non-keypoint spatial locations included in the object boundary representation.

15. The method of claim 14, wherein the generating the predetermined number of non-keypoint spatial locations is based at least on an inverse Fourier transform and one or more calculated time-domain time steps.

16. The method of claim 11, wherein the object boundary representation includes a polygonal or elliptical boundary having a quantity of vertices equal to or greater than the predicted quantity of time-domain keypoints.

17. The method of claim 11, further comprising predicting, using the trained machine learning model, a time-domain time step associated with each of the time-domain keypoints included in the set of time-domain keypoints.

18. An autonomous or semi-autonomous machine comprising:
one or more central processing units (CPUs);
one or more graphics processing units (GPUs);
one or more hardware accelerators;
one or more sensors having fields of view or sensor fields external to the autonomous or semi-autonomous machine,
wherein the autonomous or semi-autonomous machine is to perform one or more navigation or control operations based at least on an object boundary representation corresponding to an object in an image, the object boundary representation generated based at least on applying an inverse Fourier transform to a set of keypoints, wherein a number of keypoints to be included in the set of keypoints is computed based at least on a machine learning model processing image data corresponding to the image.

19. The autonomous or semi-autonomous machine of claim 18, wherein the one or more CPUs, the one or more GPUs, and the one or more hardware accelerators are comprised in one or more systems-on-a-chip (SoCs), and wherein a individual SoC of the one or more SoCs is capable of 275 tera operations per second (TOPS) of AI performance

20. The autonomous or semi-autonomous machine of claim 18, wherein the autonomous or semi-autonomous machine includes or is associated with at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
